(19) United States
(12) Patent Application Publication
(10) Pub. No.: US 2007/0064140 A1
(43) Pub. Date: Mar. 22, 2007

(54) Electronics System

(75) Inventor: Masahiro Kitaura, Kanagawa-ken (JP)

Correspondence Address: NATH & ASSOCIATES, 112 South West Street, Alexandria, VA, 22314, US

(73) Assignee: VICTOR COMPANY OF JAPAN, LIMITED., Yokohama-shi (JP)

(21) Appl. No.: 11/523,568

(22) Filed: Sep. 20, 2006

(30) Foreign Application Priority Data
Sep. 22, 2005 (JP) P2005-274958

(51) Int. Cl. H04N 5/222

(52) U.S. Cl. 348/333.01

(57) ABSTRACT

An electronics system includes an electronic appliance with a display, a video camera for photographing an operator, and a universal remote controller for remotely controlling the electronic appliance. The image of the operator photographed with the video camera is converted into a mirror image. The mirror image of the operator is overlapped with an operational image which includes control icons and a pointer, and the overlapped images are displayed on the display. The operator manipulates a button on the universal remote controller, and the universal remote controller emits light. The light is detected by a detection unit of the electronics system. When the light is brought on to the pointer, the pointer starts to follow a movement of the universal remote controller manipulated by the operator. The operator moves the pointer onto a required one of the control icons and operates the button of the universal remote controller, to execute a control operation associated with the control icon.

### BACKGROUND OF THE INVENTION

1. Field of the Invention

The present invention relates to an electronics system, and particularly, to an electronic system for remotely controlling an electronic appliance having a display, such as a television set and a personal computer.

2. Description of Related Art

In the 1980s, infrared remote controllers started to be attached to home appliances such as television sets. The remote control user interfaces have widely spread and greatly changed the usage of home appliances. At present, the operation with remote controllers is in the mainstream. The remote controller basically employs a one-push, one-function operation. A television remote controller, for example, has ON/OFF, CHANNEL, VOLUME, and INPUT SELECT keys for conducting respective functions. The remote controllers are very useful for remotely controlling the television set and electronic devices connected to the television set.

Data broadcasting that has started recently requires UP, DOWN, LEFT, RIGHT, and OK keys of a remote controller to be pushed several times to display a required menu screen. An EPG (electronic program guide) includes a matrix of items to be chosen, and a user must push keys several times on the remote controller to record a program with the EPG. In this way, operation of the remote controller on the EPG is complicated and inconvenient like the operation on data broadcasting.

To solve the problems, Japanese Unexamined Patent Application Publication No. 2003-283866 discloses a controller that obtains positional information with a pointing device such as a mouse, encodes the positional information into a time-series code string which is a time-series pattern of codes representative of pushed keys, and transmits the time-series code string to a television set.

The controller disclosed in the Japanese Unexamined Patent Application Publication No. 2003-283866 allows a user to conduct a pointing operation similar to that of a personal computer and remotely control a television set. This controller, therefore, is inconvenient for a person who is unfamiliar with the operation of a personal computer. From the view point of information literacy (ability of utilizing information), the related art is somewhat unreasonable because it forcibly introduces the handling scheme of personal computers into the handling scheme of home appliances such as television sets. A need exists in a new remote control appropriate for television sets.

With an advancement of networking, displays of television sets and personal computers are needed to display a variety of information pieces supplied from storage media and the Internet. Operation of a remote controller of a television set is dependent on information sources, and the remote controller must cope with various information sources. In this regard, present remote controllers attached to home appliances are insufficient.

To cover a variety of complicated functions of home appliances such as television sets, the conventional remote controllers must expand their sizes and capacities. In addition, the remote controllers must serve as pointing devices because data broadcasting, for example, requires many steps of pointing operations. To serve as pointing devices, the conventional remote controllers are not user-friendly. Presently, many devices each having its own remote controller are frequently networked to a display, and the networked devices are controlled with their respective remote controllers via the display. For example, it is usual to connect a television set to a VTR, a video disk, an audio unit, and the like. What is problematic is the user must find a correct one among the remote controllers when controlling one of the networked devices. In addition, the conventional remote controllers are poor at handling a variety of information pieces provided by web sites on the Internet.

### SUMMARY OF THE INVENTION

In view of the above-mentioned problems, an object of the present invention is to provide an electronics system capable of flexibly conducting remote control on a variety of electronic appliances with a single remote controller.

In order to accomplish the object, a first aspect of the present invention provides an electronics system including an electronic appliance with a display, a video camera for photographing an operator who is in front of the display, and an on-hand controller for remotely controlling the electronic appliance. The electronics system has a mirror image converter configured to convert an image photographed with the video camera into a mirror image; an operational image generator configured to generate an operational image containing at least a control image and a pointing image; a mixer configured to mix an image signal representative of the mirror image with an image signal representative of the operational image; a display controller configured to detect that, with the mixed images being displayed on the display, the pointing image has been selected when an image of the on-hand controller photographed with the video camera and displayed on the display is brought over the pointing image on the display and make the pointing image follow a movement of the on-hand controller; a detection unit configured to detect an operation of specifying the control image according to a position of the pointing image; and an appliance controller configured to control the electronic appliance according to a control operation associated with the specified control image.

According to the first aspect, the video camera photographs an operator. The photographed image of the operator is converted into a mirror image. The mirror image is mixed and overlaid with an operational image that contains a control image and a pointing image. The overlaid images are displayed on the display. When the on-hand controller manipulated by the operator and displayed on the display is brought over the pointing image on the display, the display controller detects the same and makes the pointing image follow a movement of the on-hand controller. By moving the on-hand controller, the operator can move the pointing image onto the control image. When the pointing image is brought onto the control image, the detection unit detects that the control image has been specified. Then, a control operation associated with the control image is executed. The first aspect eliminates conventional operation of choosing and pushing one button from among many buttons of a remote controller. The first aspect allows the operator to perform various control operations only by moving the on-hand controller and conducting a single select operation on the on-hand controller.

According to a second aspect of the present invention, the display controller has a plurality of detectors related to a plurality of detection sections, respectively, and configured to detect areas of the image of the on-hand controller in the detection sections, the detection sections being divided from a detection frame that is defined on the display and is used to detect a movement of the on-hand controller. The display controller calculates a motion vector of the on-hand controller according to the sum total of the areas provided by the detectors and the areas provided by the detectors or a difference between the areas detected in each pair of the detection sections that are positionally symmetrical about the center of the detection frame. The display controller moves the pointing image or the control image according to the calculated motion vector.

The second aspect detects a movement of the on-hand controller according to areas of the image of the on-hand controller in the detection sections divided from the detection frame. The sum total of the areas provided by the detectors, as well as the areas provided by the detectors or a difference between the areas detected in each pair of the detection sections that are positionally symmetrical about the center of the detection frame are used to calculate a motion vector of the image of the on-hand controller. The second aspect can correctly track a movement of the on-hand controller with the pointing image or the control image.

According to a third aspect of the present invention, the on-hand controller has at least one of an infrared emitter configured to emit remote-control infrared light and a visible light emitter configured to emit visible light and vary the visible light, as well as an operation button configured to operate one of the infrared emitter and visible light emitter. The detection unit detects the operation of specifying the control image according to a position of the pointing image when the operation button is operated.

The third aspect detects the operation of specifying the control image according to a position of the pointing image when the operation button is operated to emit light from the infrared emitter or the visible light emitter. The third aspect can surely detect the operation of specifying the control image.

In order to accomplish the object, a fourth aspect of the present invention provides an electronics system including an electronic appliance with a display, a video camera for photographing an operator who is in front of the display, and an on-hand controller for remotely controlling the electronic appliance. The electronics system has a mirror image converter configured to convert an image photographed with the video camera into a mirror image; an operational image generator configured to generate an operational image containing at least a control image; a mixer configured to mix an image signal representative of the mirror image with an image signal representative of the operational image; and a display controller configured to detect that, with the mixed images being displayed on the display, the control image has been selected when an image of the on-hand controller photographed with the video camera and displayed on the display is brought over the control image on the display and make the control image follow a movement of the on-hand controller.

According to the fourth aspect, the video camera photographs an operator. The photographed image of the operator is converted into a mirror image. The mirror image is mixed and overlaid with an operational image that contains a control image. The overlaid images are displayed on the display. When the on-hand controller manipulated by the operator and displayed on the display is brought over the control image on the display, the display controller detects the same and makes the control image follow a movement of the on-hand controller. Accordingly, the operator can move the control image to a required position on the display and create an optional operational image. In this way, the fourth aspect enables a continuously moving operation for controlling, for example, the volume.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a view roughly explaining a method of controlling an electronic appliance according to an embodiment of the present invention;

FIG. 2 is a block diagram showing elements of an electronic appliance (television set) according to an embodiment of the present invention;

FIG. 3 is a view showing an operator's image and an operational image to be combined according to an embodiment of the present invention;

FIG. 4 is a view explaining an overlapped (mixed) state of the operator's image and operational image of FIG. 3;

FIG. 5 is a view showing detection sections defined on a display and detectors of FIG. 2 corresponding to the detection sections;

FIG. 6 is a block diagram showing the details of one of the detectors shown in FIG. 2;

FIG. 7 is a block diagram showing an object extractor shown in FIG. 6;

FIG. 8 is a view explaining the hue and saturation of an object extracted by the object extractor of FIG. 7;

FIG. 9 is a view showing a brightness signal of an object extracted by the object extractor of FIG. 7;

FIG. 10 is a flowchart showing a process of calculating a hue from a color difference signal;

FIGS. 11A and 11B are graphs showing histograms and APL values provided by an object characteristics detector shown in FIG. 6;

FIG. 12 is a view showing an example of a universal remote controller according to an embodiment of the present invention;

FIGS. 13A and 13B are views roughly explaining operation with the universal remote controller of FIG. 12;

FIGS. 14A to 14D are views explaining operation of a pointer with the universal remote controller of FIG. 12;

FIGS. 15A and 15B are views explaining a relationship among a marker, a pointer, and detection sections (detectors) according to an embodiment of the present invention;

FIG. 16 is a timing chart explaining operation with the universal remote controller according to an embodiment of the present invention;

FIGS. 17A and 17B are views explaining an operational difference between the universal remote controller of the present invention and a conventional remote controller;

FIGS. 18A to 18J are views explaining relationships among the marker, pointer, and detection frame when the pointer is moved with the marker in different directions according to an embodiment of the present invention;

FIGS. 19A and 19B are views explaining barycentric coordinates allocated for the detection sections of the detection frame according to an embodiment of the present invention;

FIG. 20 is a view explaining a first technique of calculating a motion vector correction value when the marker moves to the right;

FIG. 21 is a view explaining the first technique of calculating a motion vector correction value when the marker moves in an upper right direction;

FIG. 22 is a view explaining the first technique of calculating a motion vector correction value when the marker moves in a lower left direction;

FIG. 23 is a view explaining a second technique of calculating a motion vector correction value when the marker moves to the right;

FIG. 24 is a view explaining the second technique of calculating a motion vector correction value when the marker moves in an upper right direction;

FIG. 25 is a view explaining the second technique of calculating a motion vector correction value when the marker moves in a lower left direction;

FIG. 26 is a view explaining the second technique of calculating a motion vector correction value when the marker is inclined and moves to the right;

FIG. 27 is a view explaining the second technique of calculating a motion vector correction value with the marker being at different positions relative to the detection frame;

FIG. 28 is a view explaining evaluation of calculated motion vector correction values with the marker being at the different positions shown in FIG. 27;

FIG. 29 is a block diagram showing elements of an electronic appliance (television set) according to an embodiment of the present invention;

FIGS. 30A and 30B are views showing the details of a loop filter shown in FIG. 29;

FIGS. 31A and 31B are views showing a universal remote controller according to an embodiment of the present invention;

FIGS. 32A to 32D are views explaining an icon dragging operation with the universal remote controller shown in FIGS. 31A and 31B;

FIG. 33 is a view showing an example of an EPG screen according to an embodiment of the present invention;

FIG. 34 is a view explaining a volume control operation on a playback screen according to an embodiment of the present invention; and

FIG. 35 is a view showing personal-computer-like control tools that are controllable according to an embodiment of the present invention.

### DETAILED DESCRIPTION OF EMBODIMENTS

Electronics systems according to embodiments of the present invention will be explained with reference to the drawings.

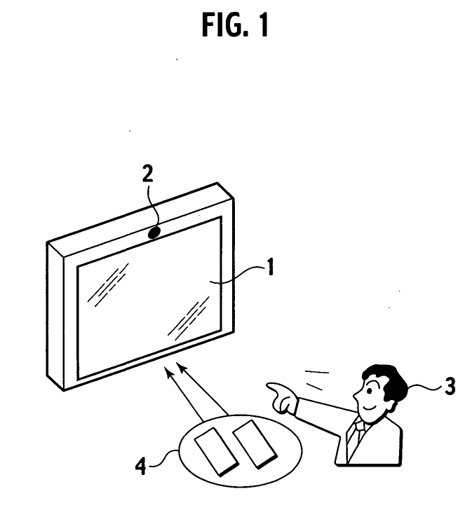

FIG. 1 shows the difference between an operation using a remote controller according to a related art and an operation according to the present invention. A user (operator) 3 operates a television set 1 . According to the related art, the user 3 must hold the remote controller 4, direct the remote controller 4 toward the television set 1 , and push a key of required function on the remote controller 4. If the television set 1 has many peripheral devices, there will be many remote controllers and the user must find a proper one from among the many remote controllers. This is inconvenient for the user 3.

On the other hand, the present invention provides the television set 1 with a video camera 2. The video camera 2 photographs the user 3. From the image provided by the video camera 2, an operation conducted by the user 3 is recognized and a control operation corresponding to the recognized operation is carried out with respect to the television set 1 or any other device connected to the television set 1 . The operation conducted by the user 3 is a movement of the remote controller to select a button in a menu displayed on the television set 1 .

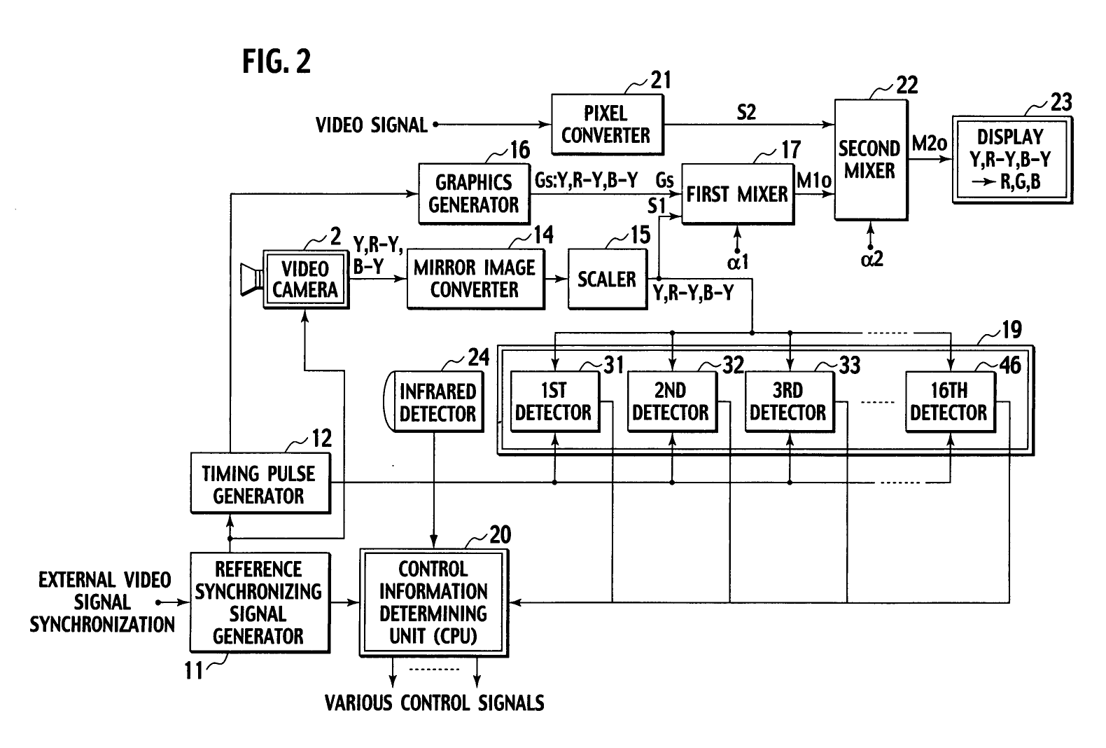

FIG. 2 is a block diagram showing a television set according to an embodiment of the present invention. The television set 1 has a reference synchronizing signal generator 11, a timing pulse generator 12, a graphics generator 16, a video camera 2, a mirror image converter 14, a scaler 15, a first mixer 17, a pixel converter 21, a second mixer 22, a display 23, a detection unit 19, an infrared detector 24, and a control information determining unit (realized in a CPU, and therefore, hereinafter referred to as CPU) 20.

The reference synchronizing signal generator 11 generates horizontal periodic pulses and vertical periodic pulses as reference signals for the television set 1. When receiving a television broadcasting signal or a video signal from an external device, the generator 11 generates pulses synchronized with a synchronizing signal of the input signal. The timing pulse generator 12 generates pulses having optional phases and widths in horizontal and vertical directions for the respective elements of FIG. 2. The video camera 2 is arranged on the front side of the television set 1 and photographs the user 3 or an object in front of the television set 1. The video camera 2 outputs a brightness (Y) signal and color difference (R-Y, B-Y) signals in synchronization with the horizontal and vertical periodic pulses provided by the reference synchronizing signal generator 11. According to this embodiment, the number of pixels of an image photographed with the video camera 2 is equal to the number of pixels of the display 23. If they are not equal to each other, a pixel converter is needed.

The mirror image converter 14 horizontally inverts an image from the video camera 2 into a mirror image, which is displayed on the display 23. If the video camera 2 provides an image of a character, it is horizontally inverted like a character image reflected from a mirror. This embodiment employs memories to horizontally invert an image into a mirror image. If the display 23 is a CRT (cathode ray tube), a horizontal deflecting operation may be reversely carried out to horizontally invert an image. In this case, other images or graphics to be mixed with an image from the video camera 2 must be horizontally inverted in advance.

The scaler 15 adjusts the size of an image photographed with the video camera 2. Under the control of the CPU 20, the scaler 15 two-dimensionally adjusts an expansion ratio or a contraction ratio of a given image. Instead of expansion or contraction, the scaler 15 may adjust horizontal and vertical phases.

The graphics generator 16 forms a menu according to a menu signal transferred from the CPU 20. If the menu signal is a primary color signal involving R (red), G (green), and B (blue) signals, the graphics generator 16 generates, from the primary color signal, a Y (brightness) signal and color difference (R-Y, B-Y) signals, which are synthesized or mixed with an image signal in a later stage. The number of planes of the generated graphics is optional. In this embodiment, the number of planes is two. The number of pixels of the generated graphics according to this embodiment is equal to the number of pixels of the display 23. If they are not equal to each other, a pixel converter is necessary to equalize them.

The first mixer 17 mixes an output signal Gs of the graphics generator 16 with an output signal S1 of the scaler 15 according to a control value α1 that controls a mixing ratio. The first mixer 17 provides an output signal M1o as follows:
M1o=α1·S1+(1−α1)·Gs

The control value α1 is a value between 0 and 1. As the control value α1 increases, a proportion of the scaler output signal Si increases and a proportion of the graphics generator output signal Gs decreases. The mixer is not limited to the one explained above. The same effect will be achievable with any mixer that receives two systems of signal information.

The detection unit 19 consists of a first detector 31, a second detector 32, a third detector 33, . . . , and a sixteenth detector 46. The number of the detectors in the detection unit 19 is sixteen in this embodiment. The number, however, is not particularly limited. The number may be dependent on application. The detectors 31 to 46 are related to icons in a menu generated by the graphics generator 16, icons representative of links, a marker of a universal remote controller, a cursor in a control screen, or a pointer of a mouse controlled by a personal computer. This will be explained later in detail.

The CPU 20 analyzes data provided by the detection unit 19 and outputs various control signals. Operation of the CPU 20 is realized by software. Algorithms of the software will be explained later. To carry out various operations, this embodiment employs hardware (functional blocks) and software (in the CPU). Classification of operations into hardware-executed operations and software-executed operations according to this embodiment does not limit the present invention.

The pixel converter 21 converts pixel counts, to equalize the number of pixels of an external input signal with the number of pixels of the display 23. The external input signal is a signal coming from the outside of the television set 1, such as a broadcasting television signal (including a data broadcasting signal) or a video (VTR) signal. From the external input signal, horizontal and vertical synchronizing signals are extracted, and the reference synchronizing signal generator 11 provides synchronized signals. The details of a synchronizing system for external input signals will not be explained here.

The second mixer 22 functions similar to the first mixer 17. The second mixer 22 mixes the output signal M1o of the first mixer 17 with an output signal S2 of the pixel converter 21 at a control value α2 that controls a mixing ratio. The second mixer 22 provides an output signal M2o as follows:
M2o=α2·M1o+(1·α2)·S2

The control value α2 is a value between 0 and 1. As the control value α2 increases, a proportion of the first mixer output signal M1o increases and a proportion of the pixel converter output signal S2 decreases. The mixer 22 is not limited to the one explained above. The same effect will be provided with any mixer that receives two systems of signal information.

The display 23 may be a CRT (cathode ray tube), an LCD (liquid crystal display), a PDP (plasma display panel), a projection display, or the like. The display 23 may employ any proper display method. The display 23 receives a brightness signal Y and color difference signals R-Y and B-Y, converts them into R, G, and B primary color signals, and displays an image accordingly.

The infrared detector 24 is a light receiver for an infrared remote controller, to decode control information and supply the decoded information to the CPU 20. According to the information from the infrared detector 24 and detection unit 19, the CPU 20 carries out an operation.

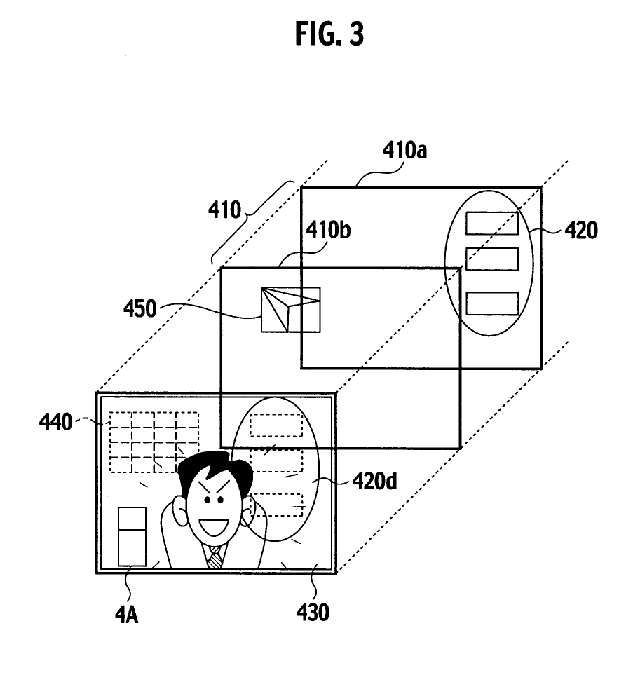

Operation of the television set 1 having the above-mentioned structure, as well as operation conducted by the user 3 will be explained. FIG. 3 shows a graphics image 410 and a scaler output image 430. The scaler output image 430 is formed by converting an image photographed with the video camera 2 into a mirror image and by scaling the mirror image so that the number of pixels of the scaler output image 430 may be equal to the number of pixels of the graphics image 410. The scaler output image 430 includes an image of the user 3 and an image of the universal remote controller 4A. The graphics image 410 consists of a menu plane 410a and a pointer (or cursor) plane 410b. The menu plane 410a has three rectangular push buttons (operation buttons) 420. The pointer plane 410b has a pointer 450. The scaler output image 430 shows mirror images of the user 3 and universal remote controller 4A photographed with the video camera 2. A dotted rectangle drawn in the scaler output image 430 is a detection frame 440. The detection frame 440 is a set of detection sections corresponding to the detectors 31 to 46 of the detection unit 19. The detection frame 440 is formed at the position of the pointer 450 of the pointer plane 410b. The scaler output image 430 also has a push-button detection section 420d three dotted rectangles that are set at the positions of the push buttons 420 of the menu plane 410a. The pointer 450 according to this embodiment is additional to the push buttons 420, functions like a mouse pointer of the personal computer, and is a very important GUI (graphical user interface) for the present invention.

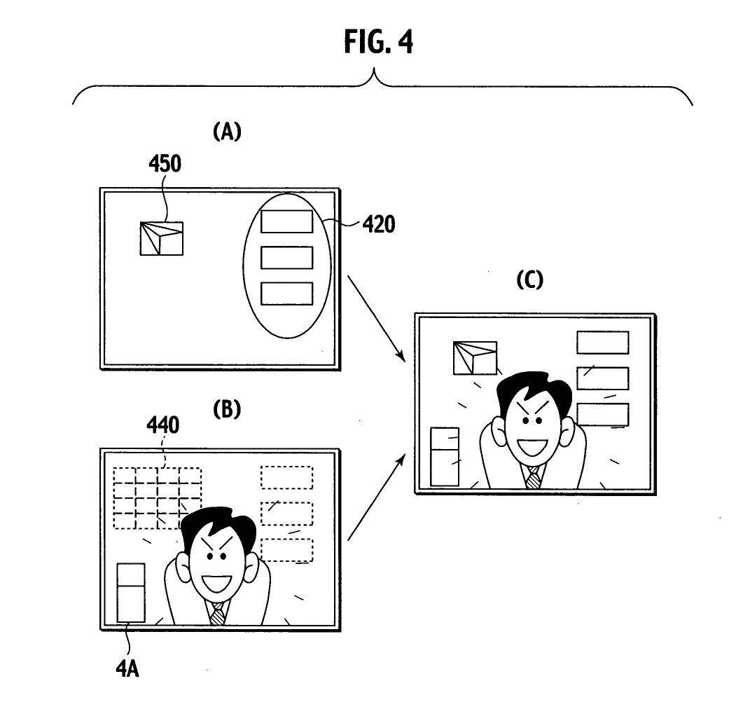

FIG. 4 shows a mixing process carried out in the first mixer 17. In FIG. 4, an image (A) is a combined image of the menu plane 410a and pointer plane 410b generated by the graphics generator 16. The image (A) includes the pointer 450 and push buttons 420. An image (B) of FIG. 4 shows the scaled mirror images of the user 3 and universal remote controller 4A photographed with the video camera 2. The image (B) also includes the detection frame 440 (indicated with dotted lines because the detection frame 440 is invisible) corresponding to the detection unit 19. An image (C) of FIG. 4 is an image formed in the first mixer 17 by mixing the images (A) and (B) at a control value α1 representing a mixing ratio. In proportion to the control value cl, the brightness and contrast of the images of the user 3 and universal remote controller 4A in the image (C) become lower than those of the image (B)

The user's mirror image and control menu are overlaid and are displayed on the display 23. As a result, the user 3 can observe each movement of the user 3 on the control menu displayed on the display 23. To conduct a control operation, the user 3 manipulates the remote controller that emits light. The light from the remote controller is detected to move the pointer 450 on the display 23, so that the user 3 may move the pointer 450 up to a push button in the control menu, or an icon having a link, or a character string having a link. Pushing a decision button of the remote controller or conducting an operation corresponding to the decision button results in providing the CPU 20 with control information corresponding to the selected button. At this time, the pointer 450 may be displayed in a different shape and/or color, to indicate for the user 3 that the user s operation has been recognized.

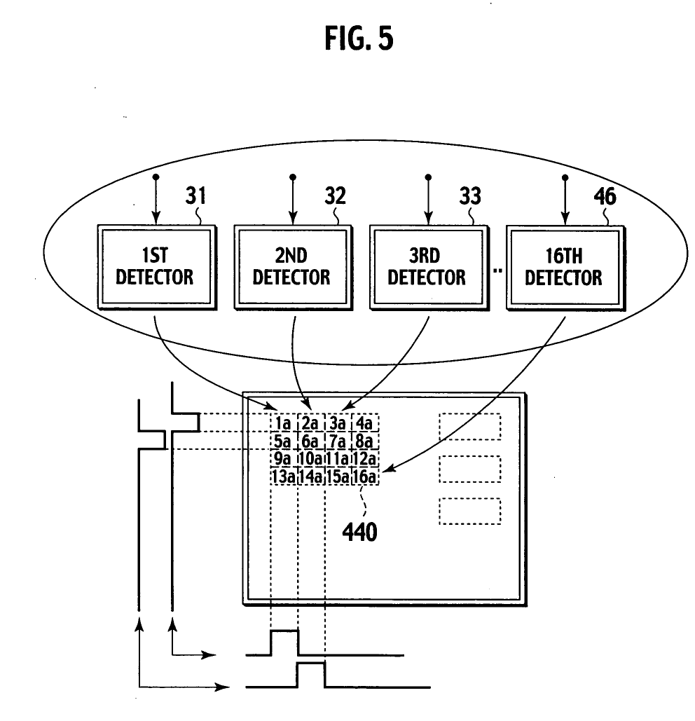

FIG. 5 shows relationships between the detection sections of the detection frame 440 of FIG. 3 set in the image from the video camera 2 and the detectors 31 to 46 of the detection unit 19. The detection sections 1a to 16a of the detection frame 440 correspond to the detectors 31 to 46, respectively. Horizontal and vertical timing pulses shown in FIG. 5 are used to identify the detection sections 1a and 6a.

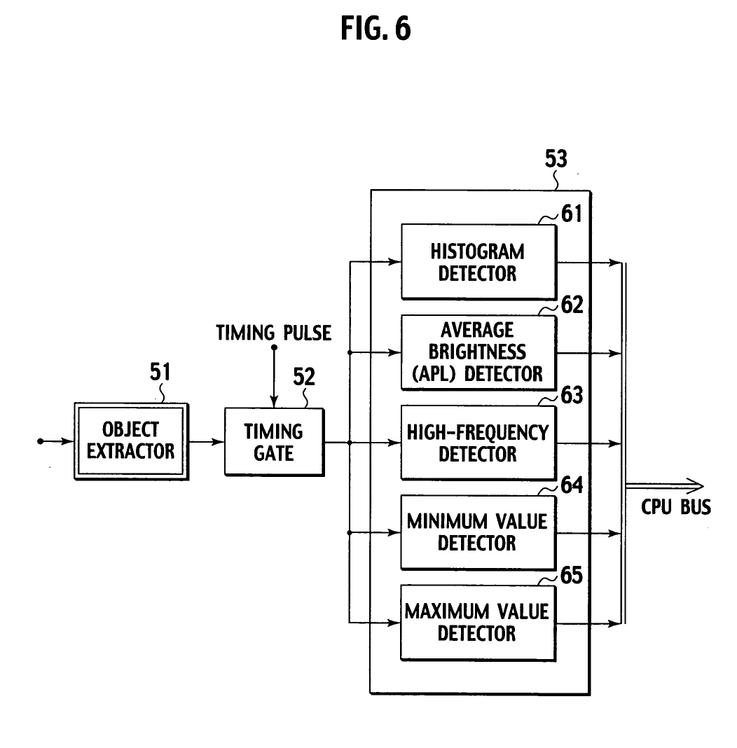

FIG. 6 shows the details of one of the detectors 31 to 46. The detector has an object extractor 51, a timing gate 52, and an object characteristics detector 53. The timing gate 52 controls the passage of an image signal from the video camera 2 according to the timing pulses shown in FIG. 5. A portion of the image signal the timing gate 52 passes is in the detection frame 440 indicated with the dotted rectangle in FIG. 5. The passed signal portion is subjected to various filtering processes to extract the hand of the user 3 and the emitter of the universal remote controller 4A photographed with the video camera 2.

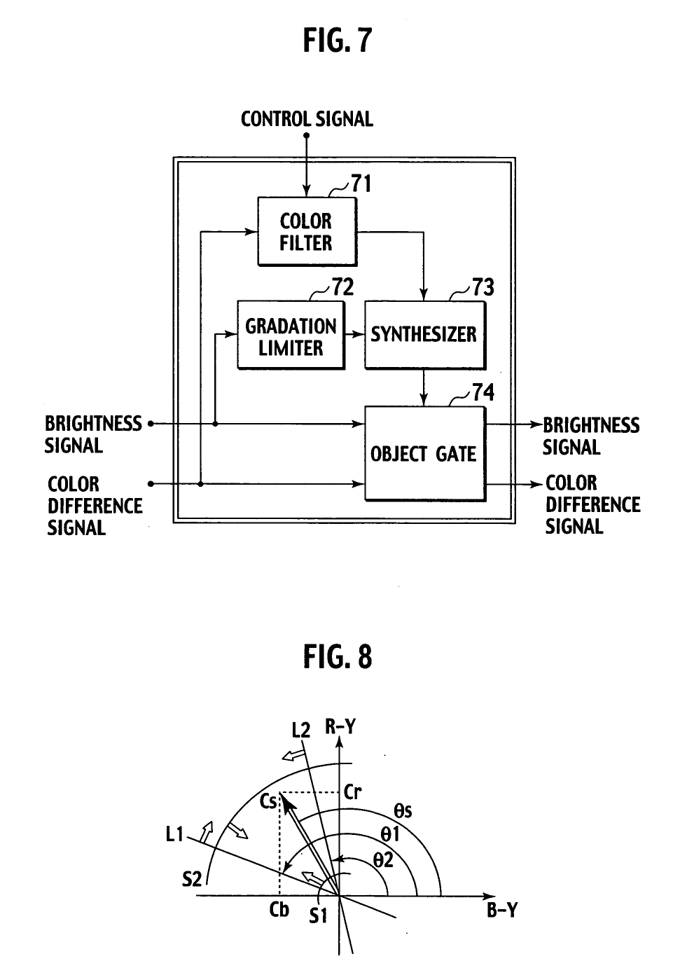

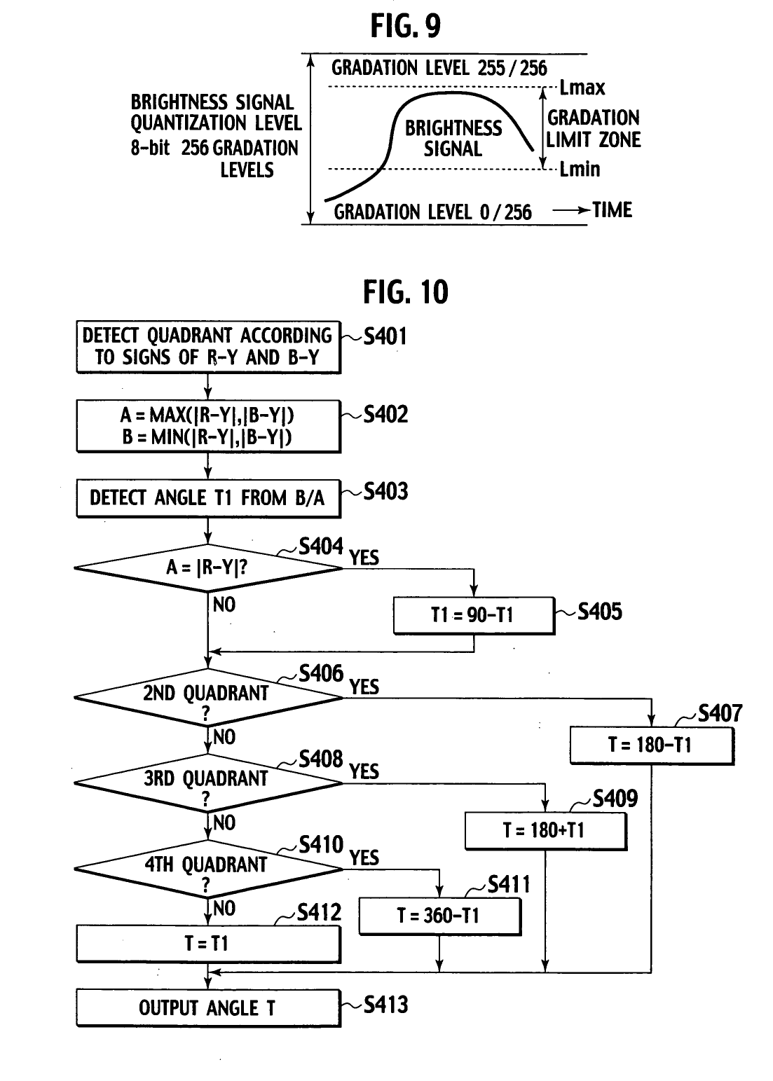

The object extractor 51 has a filter suitable for filtering the characteristics of an objective image. According to this embodiment, the remote controller is adjusted to emit light of a skin color, and therefore, the object extractor 51 carries out a filtering process suitable for detecting the skin color light from the remote controller. FIG. 7 shows the details of the object extractor 51. The object extractor 51 has a color filter 71, a gradation limiter 72, a synthesizer 73, and an object gate 74. The color filter 71 will be explained with reference to FIG. 8 that shows a color difference plane with an ordinate representing an R-Y axis and an abscissa representing a B-Y axis. Every color signal in television signals is expressible with a vector on a coordinate system of FIG. 9 and can be evaluated from polar coordinates. The color filter 71 limits the hue and color depth (degree of saturation) of a color signal consisting of color difference signals. In FIG. 8, a hue is expressed with a left-turn angle with the B-Y axis in the first quadrant serving as a reference (zero degrees). The degree of saturation is a scalar quantity of a vector. The origin of the color difference plane has a saturation degree of 0 with no color. The degree of saturation increases as it separates away from the origin, to increase the depth of color.

In FIG. 8, the color filter 71 passes a hue that falls in a range smaller than an angle of θ1 that defines an equal hue line L1 and larger than an angle of θ2 that defines an equal hue line L2. Also, the color filter 71 passes a color depth that falls in a range smaller than an equal saturation degree line S2 and larger than an equal saturation degree line S1. This range in the second quadrant corresponds to a skin-color range, i.e., the skin-color light to be extracted according to this embodiment. This, however, does not limit the present invention. The color filter 71 detects whether or not color difference signals (R-Y, B-Y) from the video camera 2 are within the range surrounded by the equal hue lines and equal saturation degree lines. To achieve this, an angle and a degree of saturation must be calculated from the color difference signals.

The angle calculation is carried out as shown in FIG. 10. Steps shown in FIG. 10 calculate, for each input pixel, an angle formed in the color difference plane of FIG. 8. The angle calculation steps shown in FIG. 10 may be realized by software or hardware. According to this embodiment, the steps of FIG. 10 are realized by hardware. In FIG. 10, step S401 refers to the signs of color difference signals R-Y and B-Y of each input pixel and detects-a quadrant in the color difference plane where the hue of the input pixel is present. Step S402 defines a larger one of the absolute values of the color signals R-Y and B-Y as A and a smaller one thereof as B.

Step S403 detects an angle T1 from B/A. As is apparent in step S402, the angle T1 is within the range of 0° to 45°. The angle T1 is calculable from a broken line approximation or a ROM table. Step S404 determines whether or not A is equal to |R-Y|, i.e., whether or not |R-Y|>|B-Y|. If |R-Y|>|B-Y| is not true, step S406 is carried out. If |R-Y|>|B-Y| is true, step S405 replaces the angle T1 with (90−T1). Then, tan⁻¹((R-Y)/(B-Y)) is calculated.

The reason why step S403 sets the range of 0° to 45° for detecting the angle Ti is because the inclination of the curve tan⁻¹ ((R-Y)/(B-Y)) sharply increases to such an extent that is improper for the angle calculation.

Step S406 employs the quadrant data detected in step S401 and determines if it is the second quadrant. If it is the second quadrant, step S407 sets T=180−T1. If it is not the second quadrant, step S408 determines whether or not it is the third quadrant. If it is the third quadrant, step S409 sets T=180+T1. If it is not the third quadrant, step S410 checks to see if it is the fourth quadrant. If it is the fourth quadrant, step S411 sets T=360−T1. If it is not the fourth quadrant, i.e., if it is the first quadrant, step S412 sets T=T1. At the end, step S413 outputs, for the pixel, the angle T in the color difference plane of FIG. 8.

With the steps mentioned above, an angle of the input color difference signals R-Y and B-Y in the color difference plane is found in the range of 0° to 360°. Steps S404 to S412 correct the angle T1 detected in step S403 to an angle T. Steps S404 to S411 correct the angle T1 according to a proper one of the first to fourth quadrants.

A color depth or a saturation degree is calculated as follows:
Vc=sqrt(Cr×Cr+Cb×Cb)
where Cr is an R-Y axis component of a color signal, Cb is a B-Y axis component as shown in FIG. 8, and “sqrt()” is an operator to calculate a square root.

This process maybe carried out by software or hardware. The multiplication and square root operations are difficult to realize by hardware and involve a large number of steps if realized by software. Accordingly, the above-mentioned process may be approximated as follows:
Vc=max(|Cr|, |Cb|)+0.4×min(|Cr|, |Cb|)
where max (|Cr|, |Cb|) is an operation to select a larger one of |Cr| and |Cb|, min (|Cr|, |Cb|) is an operation to select a smaller one of |Cr| and |Cb|, and Vc is a scalar quantity of a vector to indicate a saturation degree.

Thereafter, it is evaluated whether or not the angle (hue) T and saturation degree Vc are within the range of equal hue line angles θ1 to θ2 and within the range of equal saturation angle (color depth) lines S1 to S2. The color filter 71 of FIG. 7 passes any signal that is within these ranges.

The gradation limiter 72 of FIG. 7 is to limit specific gradation levels in a brightness signal as shown in FIG. 9. In the case of an 8-bit digital signal, there are 256 gradation levels ranging from 0 to 255. To limit a range of gradation levels, a maximum level Lmax and a minimum level Lmin are set to pass a brightness signal within this range.

The synthesizer 73 receives signals from the color filter 71 and gradation limiter 72 and provides an intraregional pulse. Namely, if there are both (AND) the signal passed through the color filter 71 and the signal passed through the gradation limiter 72, the synthesizer 73 provides a high-level pulse.

The intraregional pulse from the synthesizer 73 is supplied to the object gate 74. If the intraregional pulse is at high level, the object gate 74 passes the brightness signal and color difference signals. If the intraregional pulse is at low level, the object gate 74 blocks the input signals and outputs signal of predetermined values. According to this embodiment, the signals of predetermined values area black-level brightness signal and color difference signals of saturation degree of zero.

The timing gate 52 of FIG. 6 defines sections for the detectors on a screen according to the vertical and horizontal timing pulses shown in FIG. 5. The object characteristics detector 53 of FIG. 6 has functional blocks for detecting various characteristics from an image and includes a histogram detector 61, an average brightness level (average picture level (APL)) detector 62, a high-frequency detector 63, a minimum value detector 64, and a maximum value detector 65. An image has other specific characteristics. According to this embodiment, the characteristics detectable with the detectors 61 to 65 are used to identify light emission from the remote controller and recognize an operation carried out with the remote controller.

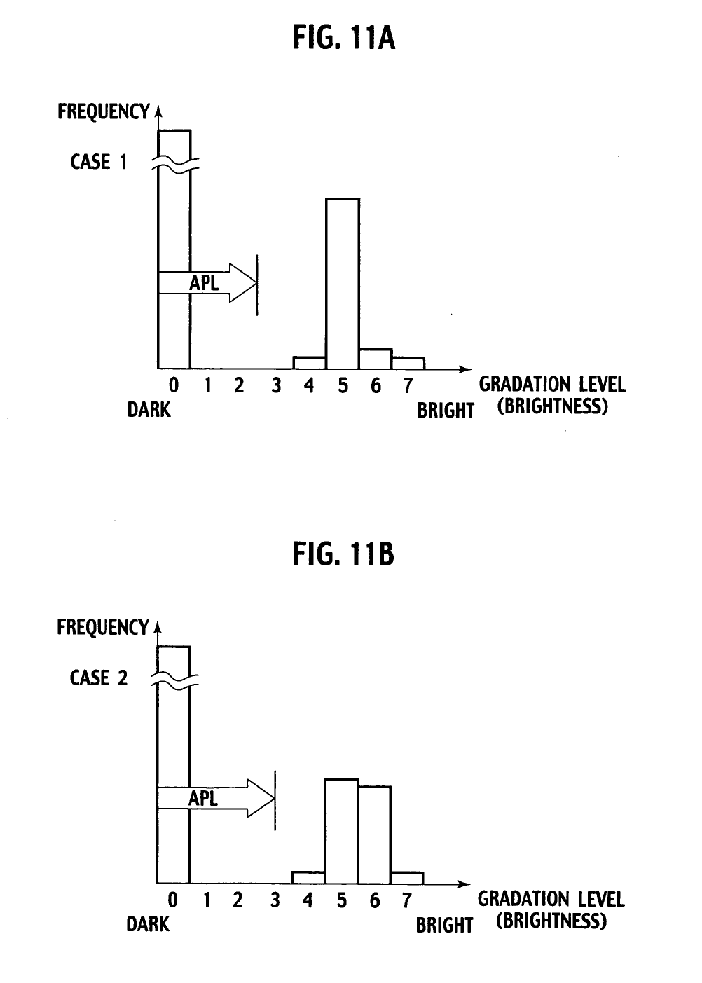

FIGS. 11A and 11B show output data from the histogram detector 61 and APL detector 62 of the object characteristics detector 53 shown in FIG. 6. Each of FIGS. 11A and 11B shows a gradation level histogram and an average brightness (APL). The APL is indicated with an arrow whose size represents the magnitude of the APL. An ordinate indicates the frequency of a gradation level group and an abscissa indicates gradation (brightness) levels separated into eight stepwise groups. A case 1 and a case 2 differ from each other in the brightness of light emission from the remote controller. In the case 1, the light emission is concentrated to a specific gradation level group. In the case 2, the light emission is dispersed mainly in two gradation level groups. The histogram and APL data are transferred to the CPU 20.

The CPU 20 operates according to software. According to the input histogram, the CPU 20 finds the sum total of gradation levels except a gradation level corresponding to black. The sum total represents a light emission area of the remote controller in the corresponding detection section of the detection frame 440. This will be explained later in detail.

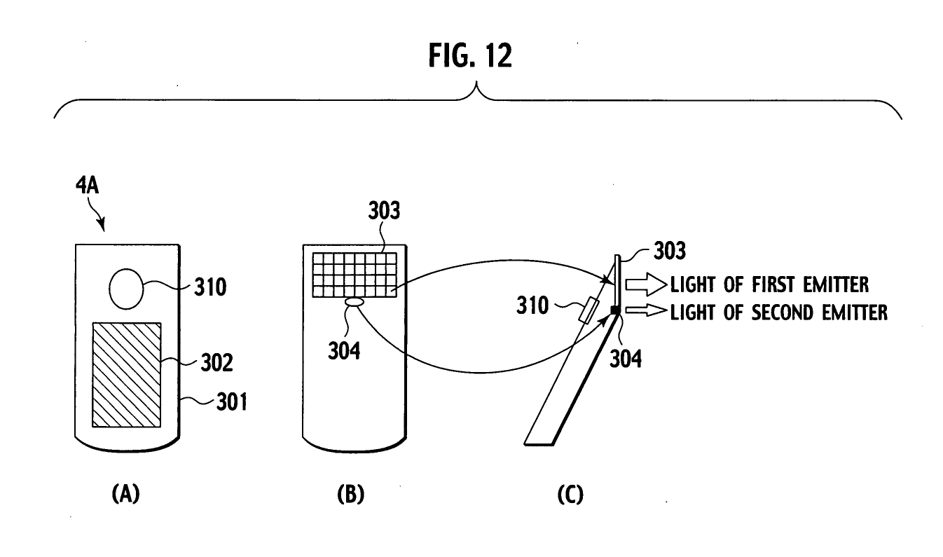

FIG. 12 shows the remote controller having a light emission function. This remote controller is a universal remote controller according to the embodiment. A view (A) of FIG. 12 shows the surface of the universal remote controller 4A facing the user 3 and manipulated by the user 3. A universal decision button 310 is arranged at an upper part of a body 301 of the universal remote controller 4A. A hatched rectangular area 302 contains conventional remote control buttons to secure compatibility. The universal decision button 310 may be surrounded with UP, DOWN, LEFT, and RIGHT keys, so that the button 310 may serve as a conventional decision key (OK key). A view (B) of FIG. 12 shows the back face of the universal remote controller 4A. A first emitter 303 is arranged at an upper part of the back face, to emit light of various colors. A second emitter 304 is arranged under the first emitter 303, to emit infrared rays. A view (C) of FIG. 12 is shows a side of the universal remote controller 4A that is slightly inclined. Arrows in the view (C) of FIG. 12 represent light from the emitters 303 and 304, respectively. The emitters 303 and 304 of the universal remote controller 4A are directed toward the television set 1 and the buttons are pushed to emit light.

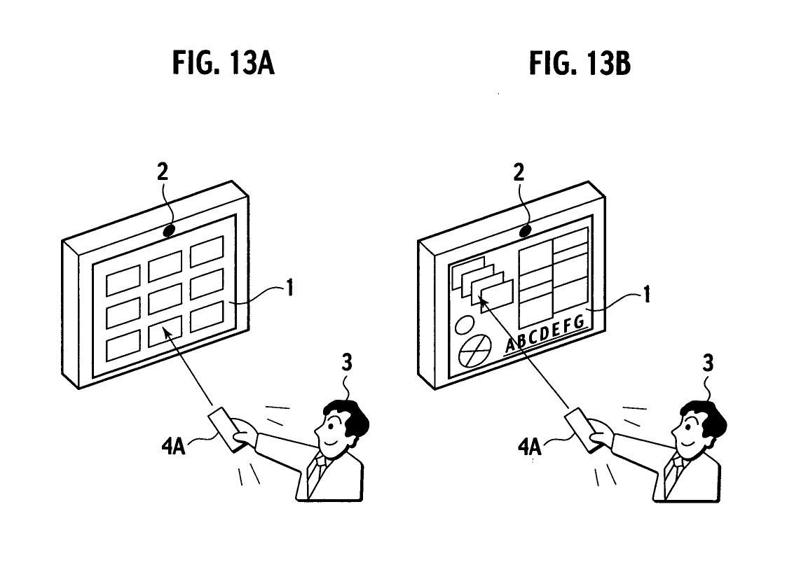

FIGS. 13A and 13B show the usage of the universal remote controller 4A. FIG. 13A shows a control method separately proposed by this applicant employing the universal remote controller. In FIG. 13A, push buttons are displayed at fixed locations in a screen of a television set. The user 3 directs the universal remote controller 4A toward the screen and emits light from the first emitter 303 of the universal remote controller 4A by manipulating the universal decision key 310, so that the light may irradiate one of the push buttons on the screen and a control operation corresponding to the irradiated push button may be executed. In addition to this method, the embodiment of FIG. 13B flexibly handles a variety of control images displayed on a screen. The control screen of FIG. 13B includes, for example, push buttons of various shapes having control information, a table having control information, and characters having link information. Similar to moving a pointer with a mouse on a personal computer to choose an icon, a linked character string, or a linked image, the embodiment of FIG. 13B allows the user 3 to conduct the same operation with the universal remote controller 4A with respect to the television set 1. According to the embodiment, the video camera 2 is used to realize remote control. An operation method using a pointer according to the present invention will be explained as a first example, and a method of dragging an icon with the universal remote controller according to the present invention will be explained as a second example.

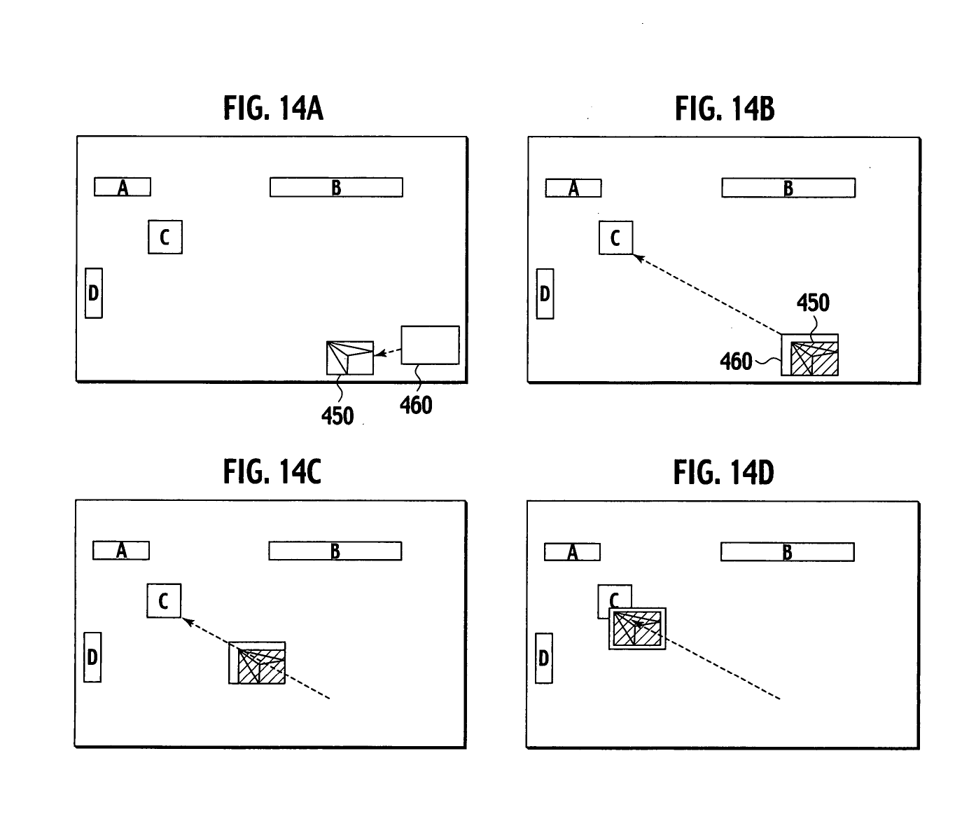

The operation method according to the first example of the present invention will be explained with reference to FIGS. 14A to 14D that show control screens displayed on the television set 1. Each control screen includes rectangle icons A, B, C, and D generated by the graphics generator 16 of FIG. 2. Each of the icons A to D is provided with control information. The control information may be media information related to CS broadcasting, BS broadcasting, terrestrial broadcasting, or the Internet, channel information related to a broadcasting station, or link information related to a homepage on the Internet. The screen also shows the pointer 450 and a marker 460 used for a pointing operation. The pointer 450 and marker 460 may move on the screen in response to operation of the universal remote controller 4A of FIG. 12. In FIG. 14A, the user 3 pushes the universal decision button 310 so that the first emitter 303 may emit light to start a pointing operation. The first emitter 303 continuously emits light while the universal decision button 310 is being pushed. The light from the first emitter 303 is photographed with the video camera 2 and is displayed as the marker 460 on the screen. The pointer 450 is generated by the graphics generator 16 and may have an optional shape. In this embodiment, the pointer 450 has a rectangular frame containing an arrow with an upper left end thereof serving as a pointing tip.

In FIG. 14B, the user 3 moves the universal remote controller 4A to bring the marker 460, which is an image of the first emitter 303, over the pointer 450. When a predetermined time passes after the marker 460 overlaps the pointer 450, the pointer 450 becomes active and changes the color thereof so that the user 3 may recognize the activation of the pointer 450. In FIG. 14B, the pointer 450 is hatched to indicate the color-changed pointer 450. The activation of the pointer 450 maybe notified by changing the shape thereof or by generating a sound. The activated pointer 450 can move together with the marker 460 on the screen. In FIG. 14B, an arrow extended from the marker 460 to the rectangular icon C indicates that the user 3 continuously pushing the universal decision button 310 is going to move the overlapping pointer 450 and marker 460 toward the icon C that has control information the user 3 requires. FIG. 14C shows the moving pointer 450 and marker 460. Namely, the pointer 450 tracks the marker 460 that represents the position of the universal remote controller 4A on the screen. FIG. 14D shows that the pointer 450 and marker 460 have reached the icon C. At this time, the user 3 releases the universal decision button 310 to turn off the light from the first emitter 303 of the universal remote controller 4A. At the same time, the second emitter 304 emits a decision code to enable the control information of the icon C. Namely, the control information related to the icon C is issued. If the control information related to the icon C is channel switching information, the television set is switched to a channel corresponding to the channel switching information.

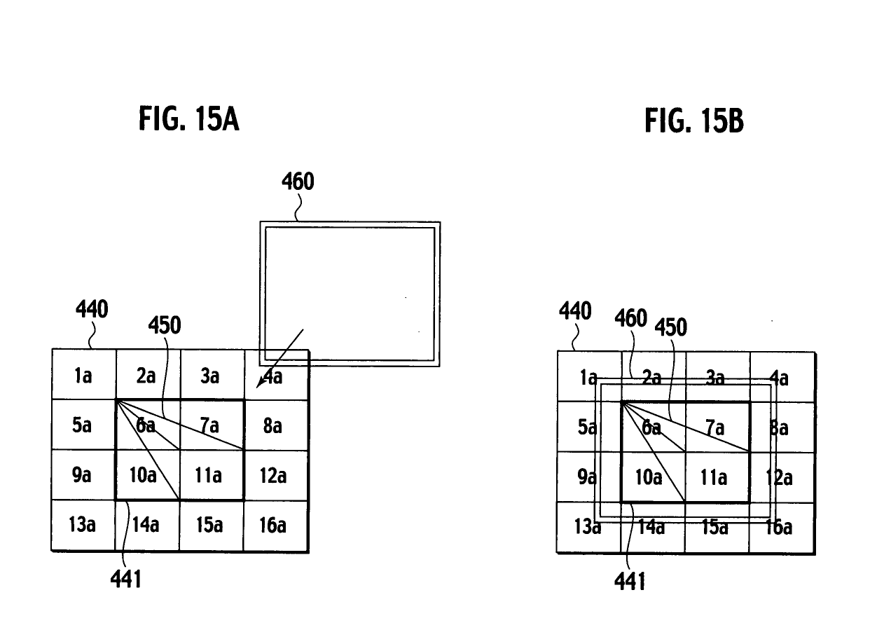

A technique of moving the pointer 450 with the marker 460 will be explained. FIGS. 15A and 15B are views explaining a relationship between the marker 460 that is an image of the first emitter 303 photographed with the video camera 2 and displayed on the display 23 and the detection frame 440 for detecting characteristics of the image of the first emitter 303, i.e., the marker 460. The detection frame 440 is divided into the sixteen detection sections 1a to 16a that correspond to the detectors 31 to 46, respectively, of the detection unit 19 shown in FIG. 2. The central four detection sections 6a, 7a, 10a, and 11a of the detection frame 440 define a pointer frame 441. In the pointer frame 441, an arrow similar to the pointer 450 of FIG. 14A is drawn. The detectors 36, 37, 40, and 41 corresponding to the pointer frame 441 function to detect the marker 460. The size of the pointer 450 is not necessary to agree with the pointer frame 441, and the pointer 450 may have an optional design. The pointer 450, however, must not be too large because the excessively large pointer deteriorates a recognition rate of the marker 460 and makes it difficult for the user 3 to grasp a relationship between the marker 460 and the pointer 450. In FIG. 15B, the marker 460 is on the pointer 450, to activate the pointer 450. At this time, the user 3 observes as if the pointer 450 is caught by the marker 460 because the color or shape of the pointer 450 changes at this time.

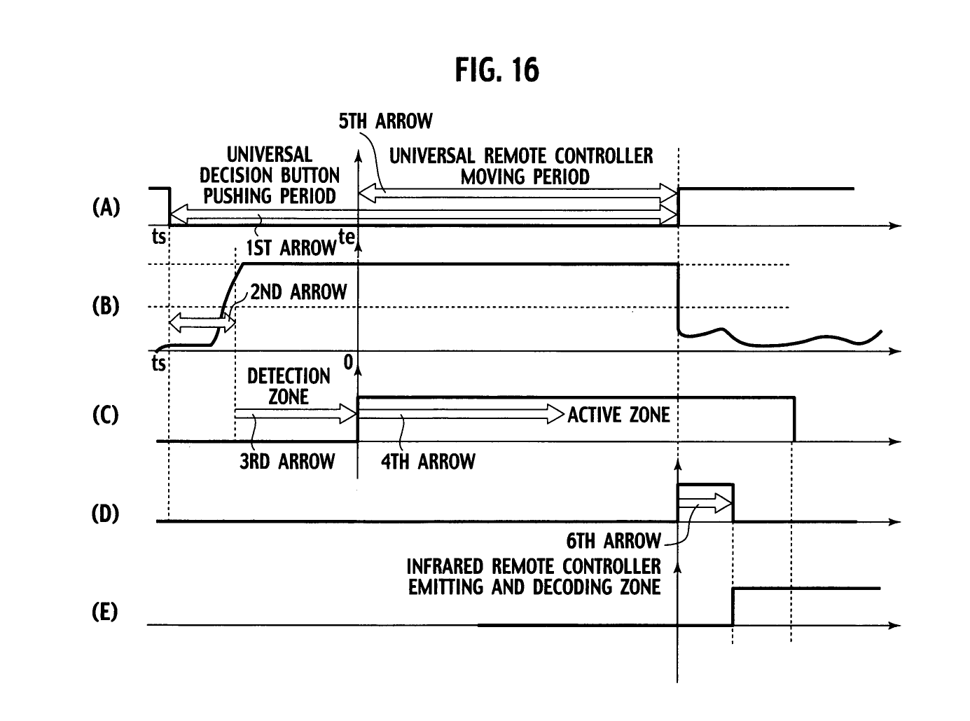

FIG. 16 is a time chart explaining the pushing and releasing operations of the universal decision button 310 and signals detected by the detection unit 19. A waveform (A) of FIG. 16 shows a period during which the universal decision button 310 is being pushed. A waveform (B) of FIG. 16 shows the sum total of histograms detected by the detectors 36, 37, 40, and 41 corresponding to the pointer frame 441. The sum total of histograms indicates an area of the pointer frame 441 covered with the marker 460. In this embodiment, the color of the marker 460, i.e., the color of light emitted from the first emitter 303 of the universal remote controller 4A is yellow. To detect this yellow light with the detection unit 19, the hue of the color filter 71 and the gradation of the gradation limiter 72 of the object extractor 51 shown in FIG. 7 are properly set.

A first arrow extending along the waveform (A) of FIG. 16 represents a period in which the universal decision button 310 is being pushed. During the period indicated with the first arrow, the waveform (A) is at a low level to indicate that the first emitter 303 of the universal remote controller 4A is emitting light. According to the first example, the user 3 pushes the universal decision button 310 and brings the marker 460 over the pointer 450 on the screen. A second arrow extending along the waveform (B) of FIG. 16 represents a period in which the marker 460 starts to move and completely overlaps the pointer 450. When the marker 460 starts to overlap the pointer 450, an area of the light from the universal remote controller 4A that passes through the pointer frame 441 gradually increases, so that the sum total of histograms detected by the detectors 36, 37, 40, and 41 increases accordingly. When the marker 460 completely covers the pointer 450, the sum total of histograms reaches a maximum. The waveform (B) of FIG. 16 shows changes in the sum total of histograms detected by the detectors 36, 37, 40, and 41.

A third arrow extending along a waveform (C) of FIG. 16 represents a period in which a cumulative area of the pointer frame 441 through which the light from the universal remote controller 4A passes reaches a predetermined level. At time “te,” the cumulative area reaches the predetermined level, and at this time, it is determined that the marker 460 has overlapped the pointer 450 and an active zone starts as indicated with a fourth arrow. At the start of the active zone, a flag is set. At this time, the color or shape of the pointer 450 changes, so that the user 3 recognizes that the marker 460 has captured the pointer 450. Then, the user 3 moves the universal remote controller 4A to a part having required control information on the screen, to make the detection frame 440 follow the universal remote controller 4A according to a moved quantity (vector) per frame detected by the corresponding detectors. When the detection frame 440 reaches the part having the required control information, i.e., the icon C of FIG. 14, the user 3 releases the universal decision button 310. A period of this movement, i.e., a period from the time “te” to the release of the universal decision button 310 is a period represented with a fifth arrow extending along the waveform (A) of FIG. 16.

As soon as the universal decision button 310 is released, the second emitter 304 of the universal remote controller 4A emits a standard infrared remote control decision code during a period indicated with a sixth arrow extending along a waveform (D) of FIG. 16. During this period, the television set 1 decodes a remote control code associated with the icon C. This period is a standard one and does not provide the user 3 with an inconvenient feeling. At a time point when a waveform (E) of FIG. 16 rises to a high level, the remote control code is decoded. Namely, the control information attached to the icon C is issued. This embodiment finalizes control information associated with an icon by using an infrared remote control code. Instead, the area of the emitter 303 of the universal remote controller 4A may be changed to determine and issue control information associated with an icon.

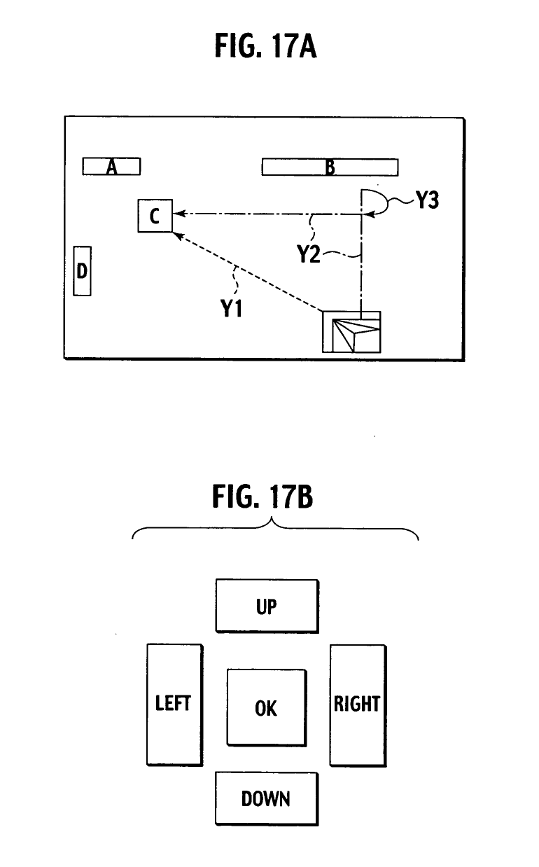

FIGS. 17A and 17B are views explaining an operational difference between the universal remote controller 4A according to the embodiment and a conventional remote controller. FIG. 17A shows a display screen similar to those of FIG. 14. There are rectangular icons A, B, C, and D provided with control information pieces, respectively. The user 3 wants the control information of the icon C, and therefore, is going to move the pointer 450 to the icon C. An arrow Y1 shown in FIG. 17A is a route to be taken by the pointer 450 according to the embodiment, and an arrow Y2 is a route to be taken by the conventional remote control operation. The conventional remote control operation is achieved with UP, DOWN, LEFT, RIGHT, and OK (decision) buttons. According to the conventional remote control, the UP, LEFT, and OK buttons are pushed in this order to guide the pointer 450 to the icon C along the route Y2. At this time, the pointer 450 may move too far with the UP button and must go back as indicated with an arrow Y3. The user 3 must pay attention to the buttons on the remote controller as well as to the screen. Namely, the user 3 must always move a line of his or her sight between the remote controller and the display. According to the embodiment, the user 3 catches the pointer 450 with the marker 460 and linearly guides the marker 460 to the icon C so that the pointer 450 may reach the icon C. According to the embodiment, the user 3 is required to push only one button, and therefore, can concentrate his or her sight on the screen. By seeing the screen, the user 3 can correct the direction of the marker 460 and guide the same to the icon C. With the universal remote controller 4A according to the embodiment, the user 3 can remotely control the television set 1, which may have a large screen, like controlling a personal computer with a mouse.

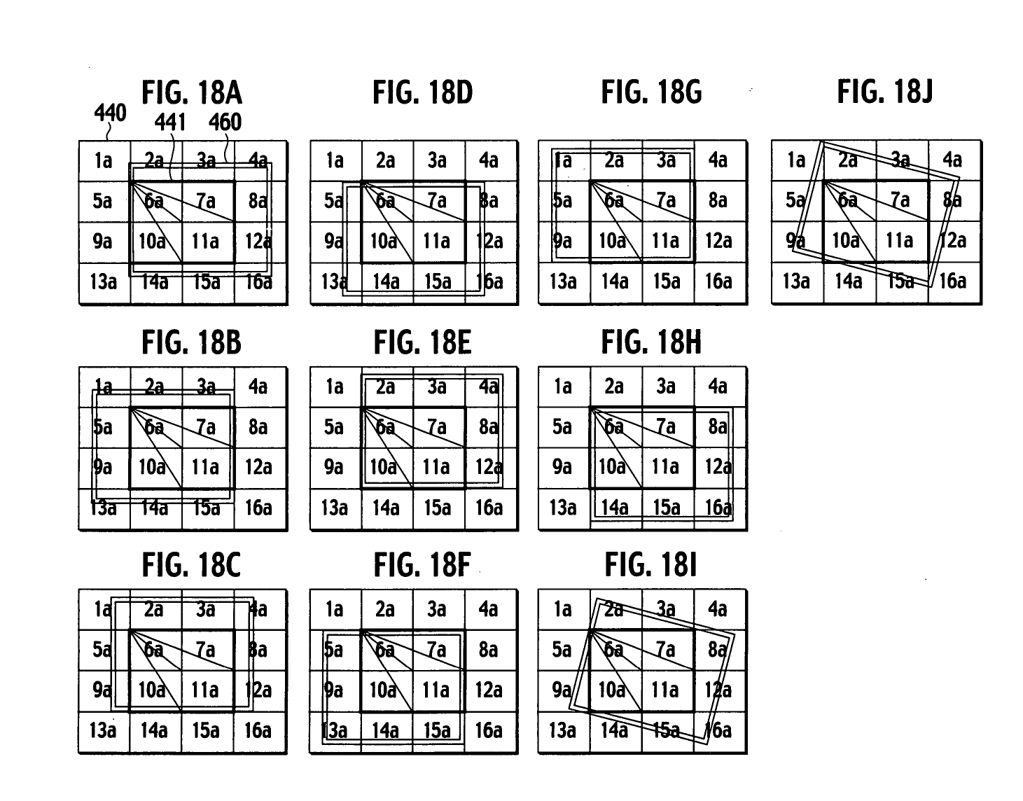

The operations of detecting the marker 460, activating the pointer 450, moving the marker 460 and pointer 450 to an objective icon, and determining a control operation have been explained with reference to FIGS. 14A to 14D and 16. Next, a technique of making the pointer 450 follow a movement of the marker 460, which is an image of the first emitter 303 of the universal remote controller 4A, will be explained. FIGS. 18A to 18J show relationships among the marker 460, detection frame 440, and pointer frame 441 in connection with ten moving directions of the pointer 450. More precisely, the marker 460 moves to a rightward direction in FIG. 18A, a leftward direction in FIG. 18B, an upward direction in FIG. 18C, a downward direction in FIG. 18D, an upper right direction in FIG. 18E, a lower left direction in FIG. 18F, an upper left direction in FIG. 18G, and a lower right direction in FIG. 18H. In FIGS. 18I and 18J, the marker 460 is inclined and moves to a rightward direction in FIG. 18I and an upward direction in FIG. 18J.

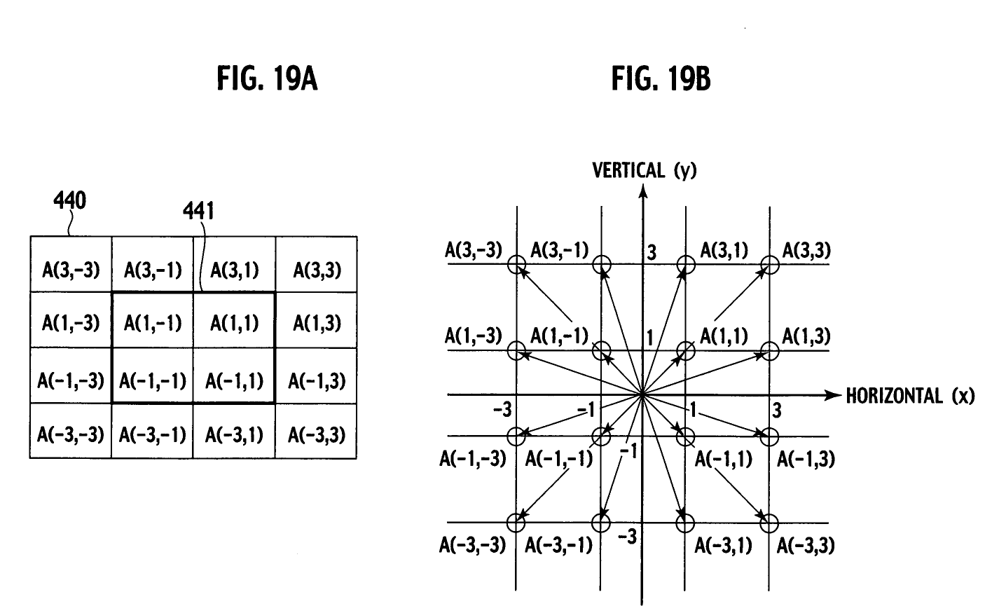

The technique of making the pointer 450 track the marker 460 will be explained in detail. FIG. 19A shows the detection frame 440, detection sections 1a to 16a defined in the detection frame 440 and corresponding to the detectors 31 to 46, respectively, and basic coordinates of the center (the center of gravity) of each of the detection sections 1a to 16a. By changing the basic coordinates, the pointer 450 can be moved to an optional position on the screen. Each of the detectors 31 to 46 provides the CPU 20 with basic coordinate data, which is set in an array A(y, x). The elements y and x of the array A represent coordinates of the center of one of the detection sections 1a to 16a. These coordinates are those at a front end of a vector extended from the origin. The embodiment calculates motion vector correction values from areas and coordinate data provided by the detectors 31 to 46.

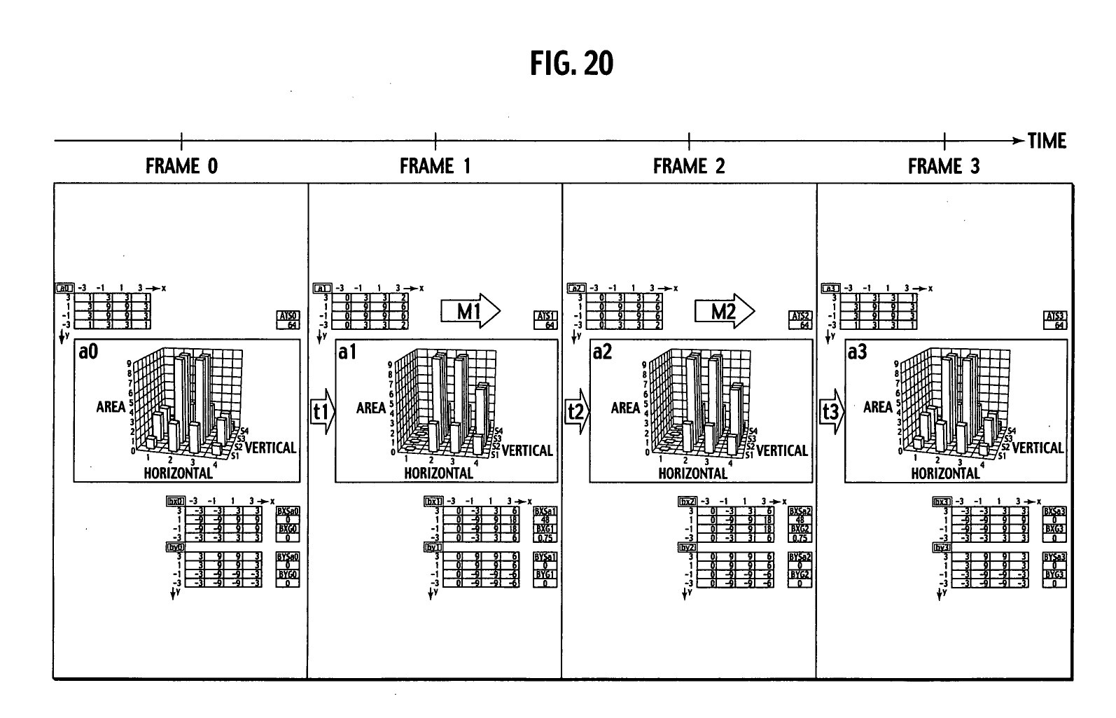

FIG. 20 is a view explaining a first calculation technique of motion vector correction values. In FIG. 20, frames 0 to 3 show video signals provided by the video camera 2. A frame period is 1/60 seconds. If the video signals are NTSC signals, an image is formed by interlace scanning. In the interlace scanning, odd lines and even lines are separately processed field by field.

In FIG. 20, the frames 0 to 3 contain tables a0 to a3, respectively. Each of the tables a0 to a3 show values provided by the detectors 31 to 46. These values correspond to the detection sections 1a to 16a of the detection frame 440, respectively. The value provided by each detector indicates an area of the marker 460 in the corresponding detection section. The coordinates of each detection section is expressed as follows:
a(n, y, x)
where n is a frame number (0, 1, 2, or 3) and y and x are coordinates of the center of the detection section. The graph in each table shows the coordinates of the detection sections 1a to 16a on a two-dimensional plane and areas detected by the detectors 31 to 46 with vertical bars.

The table a0 in the frame 0 corresponds to the situation of FIG. 15B in which the center (the center of gravity) of the pointer 450 agrees with the center (the center of gravity) of the marker 460. The tables a1 and a2 of the frames 1 and 2 are obtained when the marker 460, i.e., the universal remote controller 4A is moved in a rightward direction relative to the pointer 450, so that the center of the marker 460 is shifted to the right from the center of the pointer 450. Frame 3 shows a state that the state of the frame 2 is corrected by the motion vector correction technique according to the embodiment to bring the center of the pointer 450 onto the marker 460 and restore the state of the frame 0.

To make the pointer 450 follow a movement of the marker 460, a shift between the center of the marker 460 and the center of the pointer 450 is calculated as a motion vector correction value, and according to the calculated value, the graphically generated pointer 450 and the detection sections are moved. The first calculation technique of a motion vector correction value will be explained. In the table a0 of the frame 0 in FIG. 20, the sum total of areas of the marker 460 detected in the detection sections 1a to 16a is obtained as ATSO. The sum total ATSO is nearly constant if the marker 460 is within the detection frame 440 and if there is no noise. The sum total of areas detected in the detection sections 1a to 16a can be generalized for each frame as follows:

$$ATS ( n ) = {\sum }_{i = - 2}^{N - 1} {\sum }_{j = - 2}^{M - 1} a ( n , 2 j + 1 , 2 i + 1 ) \qquad ( 1 )$$

where N=M=2, i and j are integers and are −2, −1, 0, and 1 in this embodiment to make coordinate values of −3, −1, 1, and 3 as shown in FIG. 20, and n is a frame number, i.e., 0 for the frame 0.

To the area detected in each detection section, positional information is added. In the frame 0 of FIG. 20, an array bx0 is prepared for the horizontal x-axis and an array by0 for the vertical y-axis. The sum total of the array bx0 is BXSa0 and the sum total of the array by0 is BYSa0. These sum totals of arrays can be generalized for each frame as follows:

$$\begin{matrix}BXS a ( n ) = {\sum }_{i = - 2}^{N - 1} {\sum }_{j = - 2}^{M - 1} a ( n , 2 i + 1 , 2 j + 1 ) \times i & ( 2 ) \\ BYS a ( n ) = {\sum }_{i = - 2}^{N - 1} {\sum }_{j = - 2}^{M - 1} a ( n , 2 i + 1 , 2 j + 1 ) \times j & ( 3 )\end{matrix}$$

In the frame 0 of FIG. 20, a variation in the center of the marker 460 along the x-axis is BXG0 and that along the y-axis is BYG0. The center variations can be generalized for each frame according to the expressions (1), (2), and (3) as follows:

$$\begin{matrix}BXG ( n ) = \frac{BXS a ( n )}{ATS ( n )} & ( 4 ) \\ BYG ( n ) = \frac{BYS a ( n )}{ATS ( n )} & ( 5 )\end{matrix}$$

Motion vector correction values Vx and Vy for moving the pointer 450 and detection frame 440 are obtained as follows:
Vx(n)=Cx·BXG(n) (6)
Vy(n)=Cy·BYG(n) (7)
where Cx and Cy are conversion coefficients.

In FIG. 20, a maximum of the area of the marker 460 in each detection section is set to 9. In the frames 1 and 2, the marker 460 moves to the right. Namely, the center of the marker 460 moves to the right relative to the center of the detection frame 440. Moved quantities of the center of the marker 460 are BXG1=0.75 and BYG1=0 in the frame 1 and BXG2=0.75 and BYG2=0 in the frame 2. Multiplying these quantities by the conversion coefficients Cx and Cy provides motion vector correction values. The conversion coefficients Cx and Cy are important and determined according to the number of pixels in the detection frame 440, the aspect ratio of the detection frame 440, a tracking speed, and the like. The motion vector correction values Vx and Vy obtained as mentioned above are quantities to move the detection frame 440 and pointer 450 in the x- and y-axis directions.

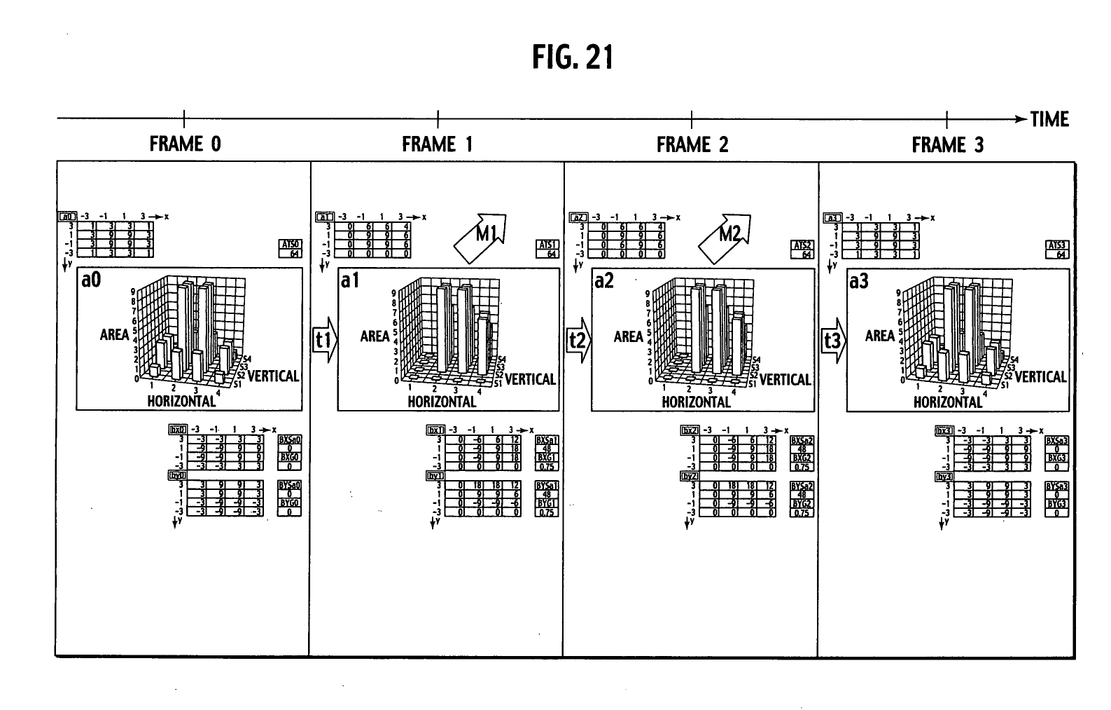

FIG. 21 shows a case to move the marker 460 in an upper right direction relative to the pointer 450. In frames 1 and 2, the marker 460 is moved in the upper right direction by BXG1 of 0.75 and BYG1 of 0.75 in the frame 1 and BXG2 of 0.75 and BYG2 of 0.75 in the frame 2. The detection frame 440 and pointer 450 are moved in the upper right direction accordingly.

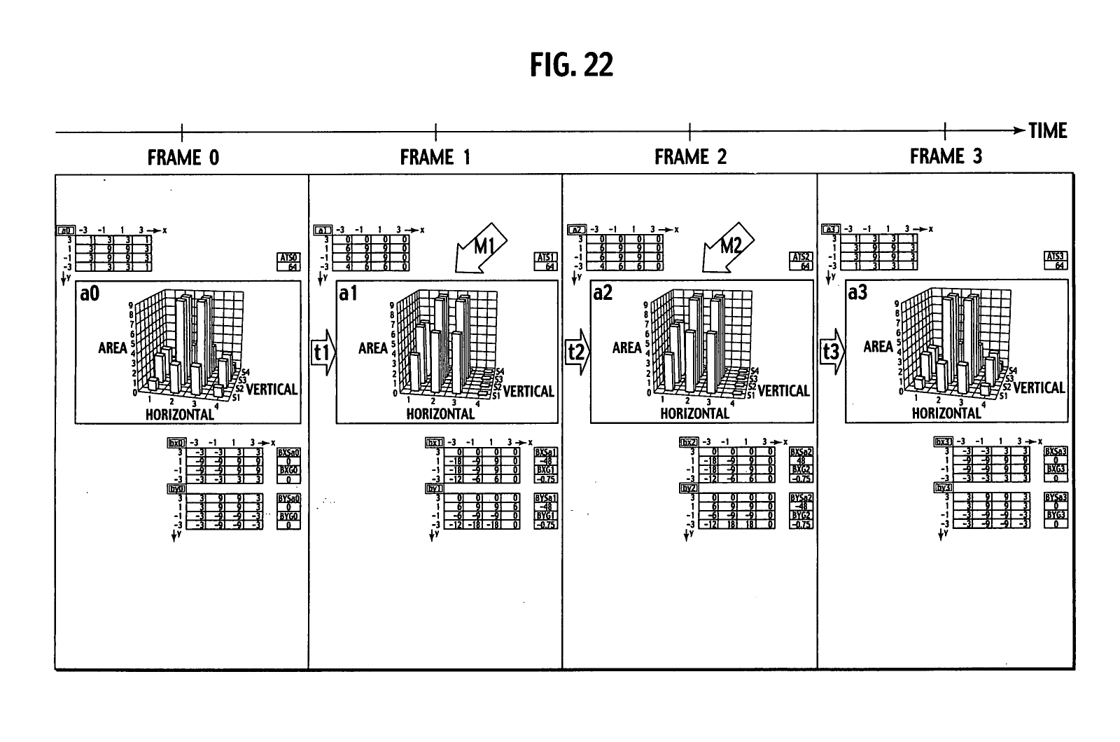

FIG. 22 shows a case to move the marker 460 in a lower left direction relative to the pointer 450. In frames 1 and 2, the marker 460 is moved in the lower left direction by BXG1 of −0.75 and BYG1 of −0.75 in the frame 1 and BXG2 of −0.75 and BYG2 of −0.75 in the frame 2. The detection frame 440 and pointer 450 are moved in the lower left direction accordingly.

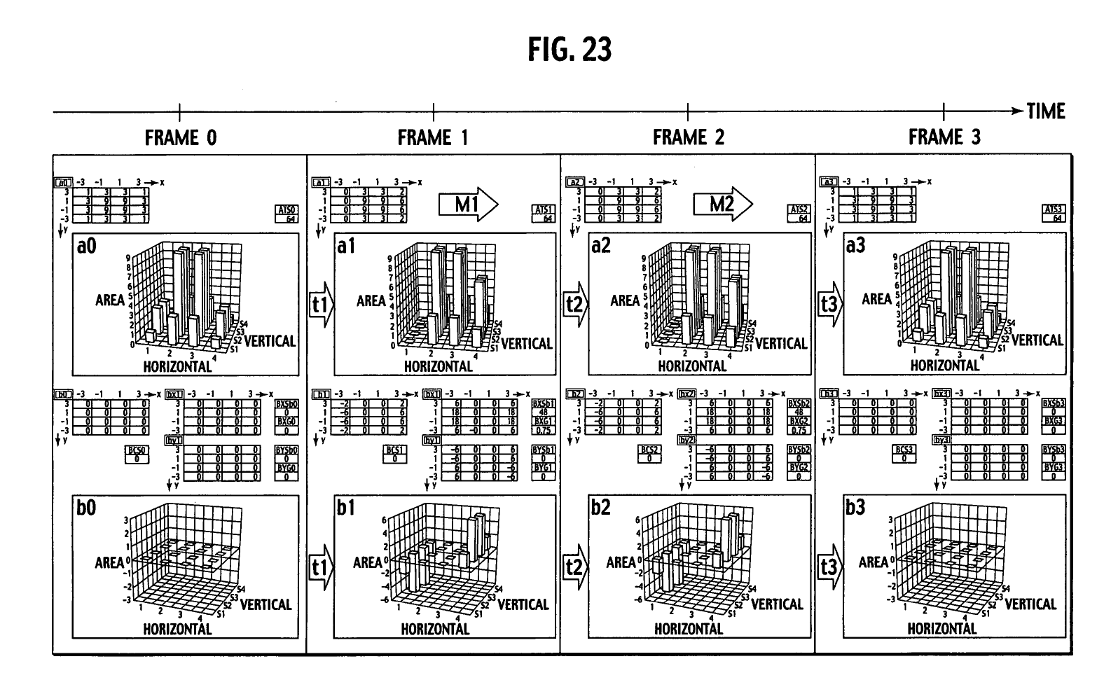

FIG. 23 is a view explaining a second technique of calculating motion vector correction values. Similar to FIG. 20, FIG. 23 shows frames 0 to 3 containing tables a0 to a3. The table a0 of the frame 0 shows a state in which the center of the pointer 450 agrees with the center of the marker 460 as shown in FIG. 15B. At this time, the pointer 450 is stopped. Under this state, motion vector values are calculated. Values in the table a0 are partial areas of the marker 460 detected in the detection sections 1a to 16a, respectively. These values are symmetrical with respect to the center (origin) of the table a0 because the centers of the pointer 450 and marker 460 agree with each other. A table b0 is prepared from the table a0 as follows:
b(n, y, x)=a(n, x, y)−a(n, −x, −y) (8)
x=2i+1, y=2j+1
where i and j are integers and are −2, −1, 0, and 1 in this embodiment to make coordinate values of −3, −1, 1, and 3, and n is a frame number, i.e., 0 for the frame 0.

The expression (8) calculates a difference between values that are positionally symmetrical about the origin in the table a0. When the centers of the detection frame 440 and marker 460 agree with each other, each difference is zero.

The frame 1 of FIG. 23 corresponds to FIG. 18A in which the universal remote controller 4A is moved to the right. At this time, the center of the marker 460 moves to the right, and values in the detection sections 1a to 16a become as those shown in a table a1 of the frame 1 of FIG. 23. In the frame 1, a table b1 shows origin symmetrical difference values. The right side (x being positive) of the table b1 shows positive values and the left side (x being negative) of the table b1 shows negative values. A table bx1 and a table by1 on the right side of the table b1 show values containing coordinates and calculated as follows:
bx(n, y, x)=x·b(n, y, x) (9)
by(n, y, x)=y·b(n, y, x) (10)
x=2i+1, y=2j+1
where i and j are integers and are −2, −1, 0, and 1 in this embodiment to make coordinate values of −3, −1, 1, and 3, and n is a frame number, i.e., 1 for the frame 1.

In the frame 1, bx(1, y, x) and by (1, y, x) are vector information containing coordinates.

In the frame 1, BXSb1 and BYSb1 are the sum totals of the values in the tables bx1 and by1, respectively. These sum totals can be generalized for each frame as follows:

$$\begin{matrix}BXS b ( n ) = \frac{1}{2} {\sum }_{i = - 2}^{N - 1} {\sum }_{j = - 2}^{M - 1} b x ( n , 2 i + 1 , 2 j + 1 ) \times i & ( 11 ) \\ BYS b ( n ) = \frac{1}{2} {\sum }_{i = - 2}^{N - 1} {\sum }_{j = - 2}^{M - 1} b y ( n , 2 i + 1 , 2 j + 1 ) \times j & ( 12 )\end{matrix}$$

Center variations BXGb1 and BYGb1 in the frame 1 can be obtained from the following generalized expressions according to the sum total ATS(n) for the array a1 of the expression (1) and the above-mentioned BXSb(n):

$$\begin{matrix}BXG ( n ) = \frac{BXS b ( n )}{ATS ( n )} & ( 13 ) \\ BYG ( n ) = \frac{BYS b ( n )}{ATS ( n )} & ( 14 )\end{matrix}$$

BXSa (n) and BYSa (n) of the first calculation technique and BXSb(n) and BYSb(n) of the second calculation technique are identical to each other. Namely, they provide the same calculation results through different processes, and therefore, are distinguished from each other with the suffixes a and b.

Motion vector correction values Vx and Vy for moving the pointer 450 and detection frame 440 according to the second calculation technique are obtained from the expressions (6) and (7) of the first calculation technique.

In the frame 2 of FIG. 23, the marker 460 is moved to the right, and according to the movement, the detection frame 440 is moved at a constant speed while keeping the state of FIG. 18A. As a result, data in the frame 2 is the same as that in the frame 1. In the frame 3, the marker 460 is stopped, and therefore, each vector value becomes zero.

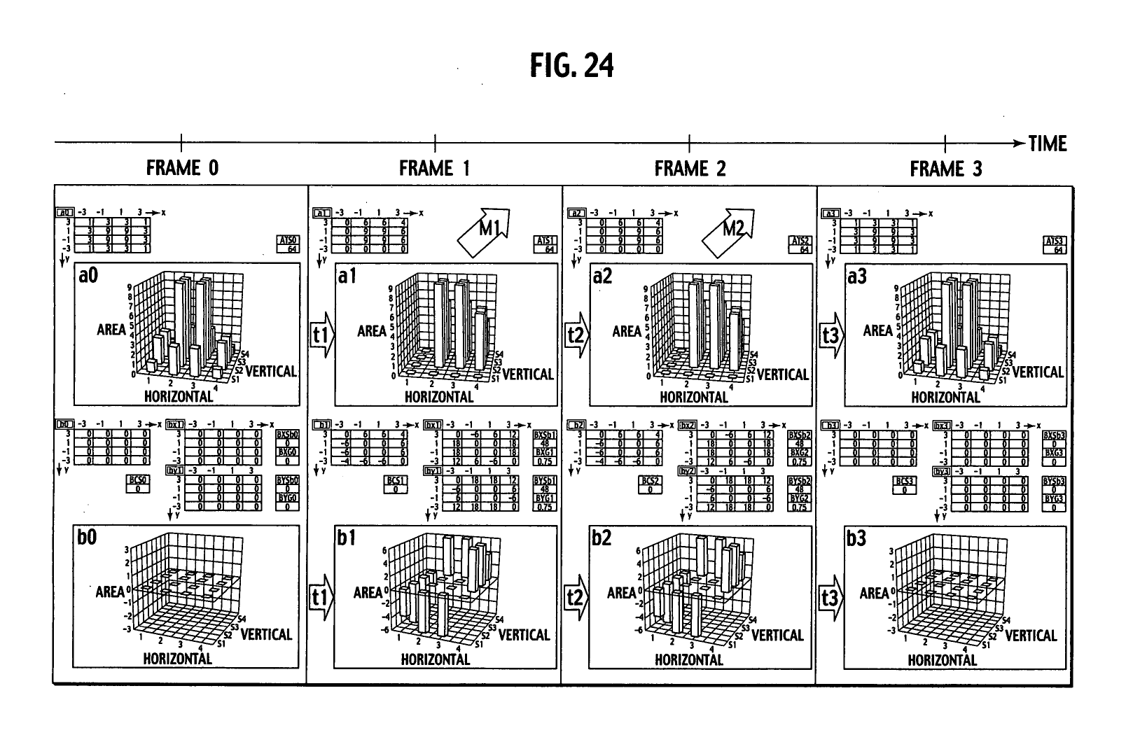

FIG. 24 also shows the second calculation technique but when the marker 460 moves in a upper right direction.

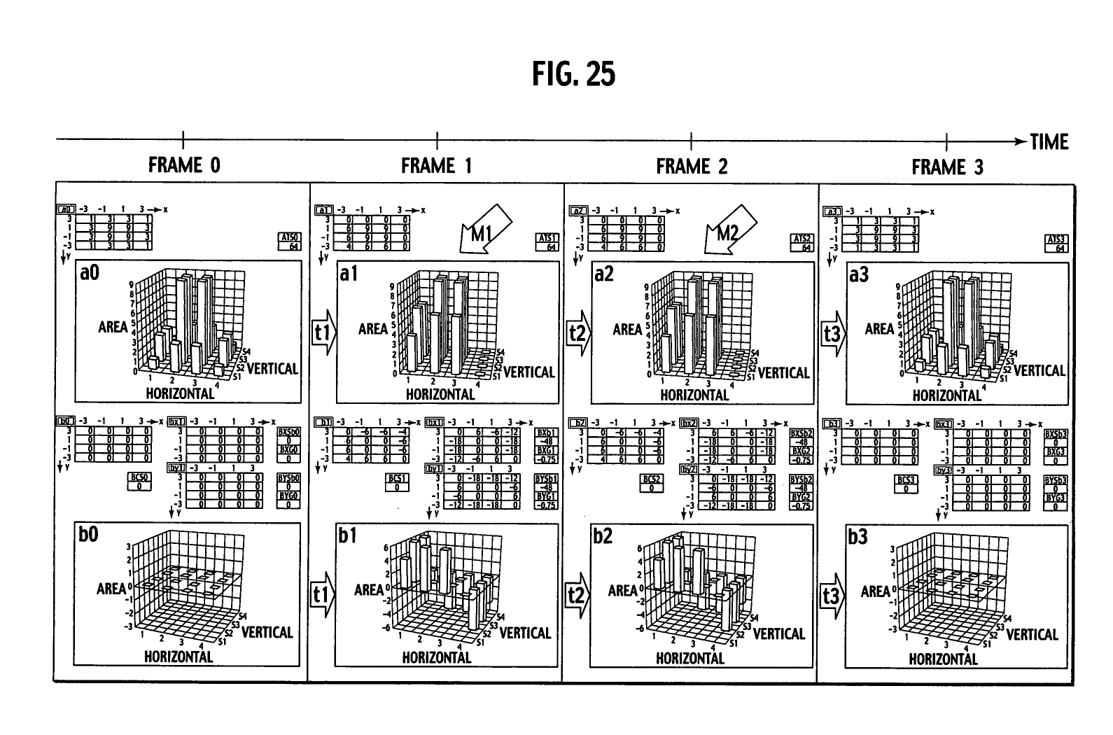

FIG. 25 also shows the second calculation technique but when the marker 460 moves in a lower left direction.

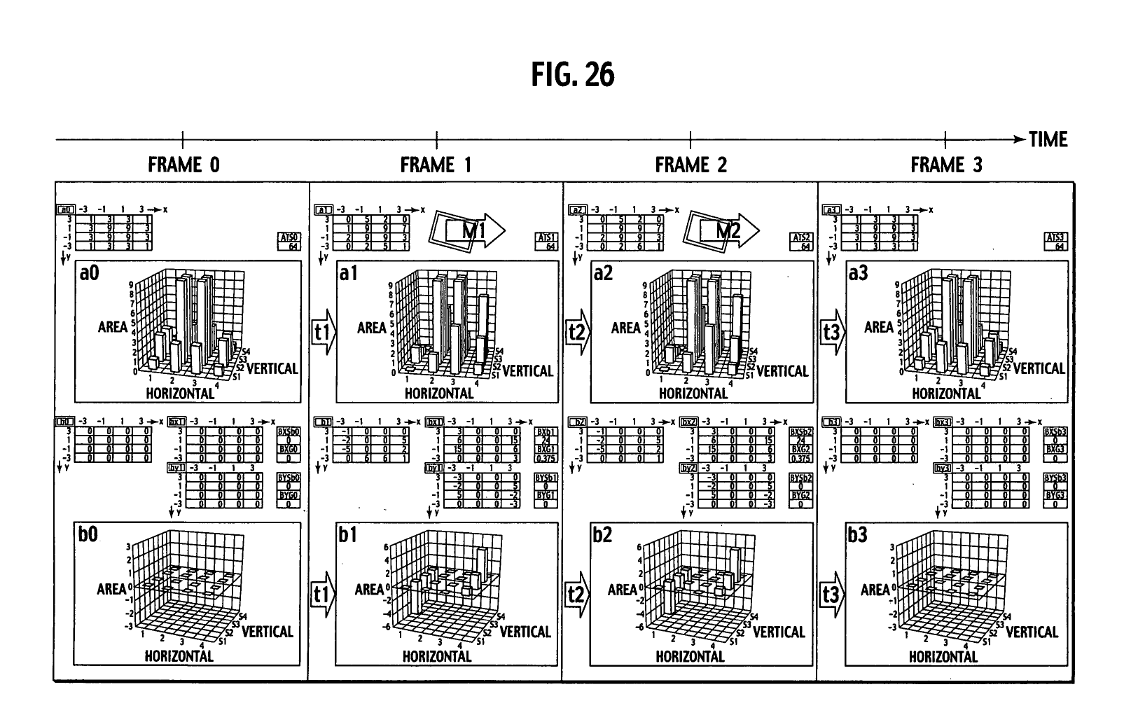

FIG. 26 also shows the second calculation technique but when the marker 460 is inclined and moves to the right. The universal remote controller 4A is manipulated by a person, and therefore, it may frequently incline. The calculation technique mentioned above can detect a positional variation of the center of the detection frame 440 as motion vectors, and therefore, can correctly move the detection frame 440 according to a movement of the marker 460, as long as the symmetry of values calculated with the expression (8) is not greatly broken.

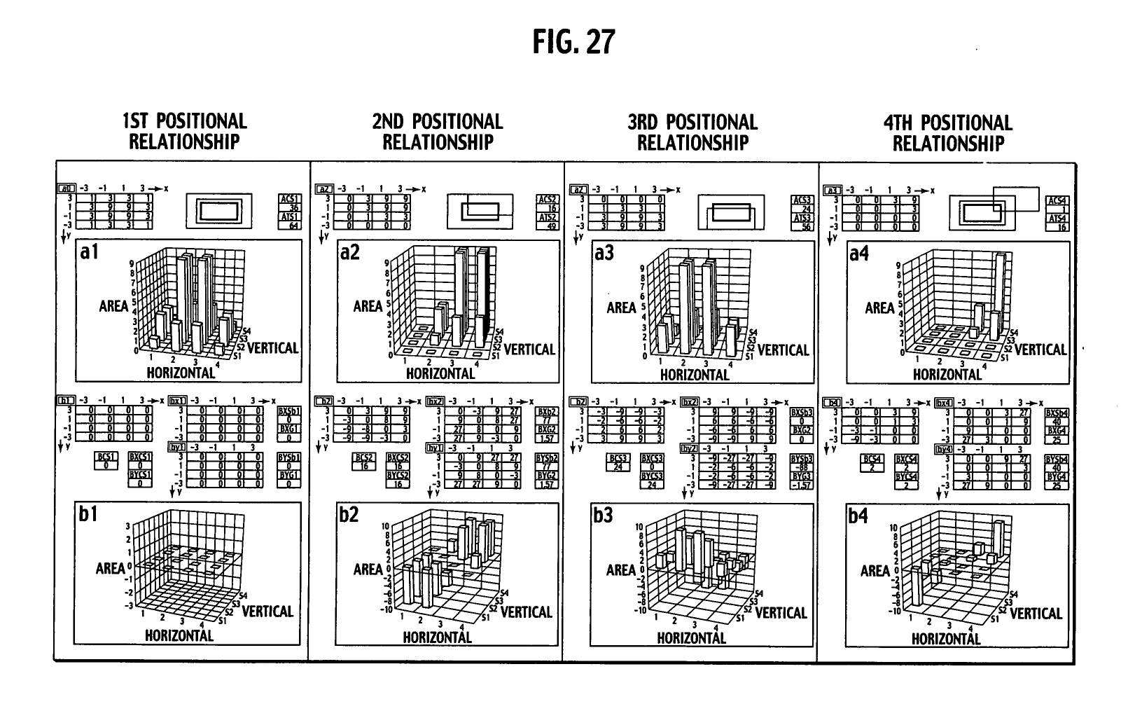

FIG. 27 shows first to fourth positional relationships between the detection frame 440 and the marker 460, to explain the characteristics of motion vector detection used for the second calculation method. Unlike FIGS. 20 to 26 that show temporal changes frame by frame, FIG. 27 shows four positional relationships between the detection frame 440 and the marker 460 without regard to time. According to the embodiment, the detection frame 440 is divided into the sixteen detection sections 1a to 16a. If the detection frame 440 and marker 460 are excessively separated from each other, the embodiment restricts an excessive movement of the pointer 450. This will be explained in detail in connection with the first positional relationship.

In the first positional relationship of FIG. 27, a table a1 show partial areas of the marker 460 detected in the detection sections 1a to 16a, respectively, a table b1 shows origin symmetrical difference values (the expression (8)), BXSb1 and BYSb1 are obtained by multiplying the values of the table b1 by coordinates and summing up (the expressions (11) and (12)), and BXG1 and BYG1 are positional variations of the center of the marker 460 relative to the center of the detection frame 440. These are the same as those explained above. To explain the positional relationship, additional factors are introduced. Namely, ACS1 is the sum total of values detected in the detection sections of the pointer frame 441 (a(1, 1), a(1, −1), a(−1, 1), and a(−1, −1) of FIG. 19A), BCS1 is the sum total of the absolute values of origin symmetrical difference values of the pointer frame 441, BXCS1 and BYCS1 are sum totals obtained from tables bx1 and by1 for the pointer frame 441. Tables and values in the second to fourth positional relationships shown in FIG. 27 are obtained like those of the first positional relationship.

According to the first positional relationship, the center of the marker 460 agrees with that of the detection frame 440 and the four detection sections of the pointer frame 441 are completely covered with the marker 460. According to the second positional relationship, the marker 460 is positioned at an upper right part of the detection frame 440 and is slightly out of the four detection sections of the pointer frame 441. According to the third positional relationship, the marker 460 is positioned at a lower part of the detection section 440 and is slightly out of the detection sections of the pointer frame 441. According to the fourth positional relationship, the marker 460 is positioned at an upper right part of the detection frame 440 and is substantially out of the detection sections of the pointer frame 441.

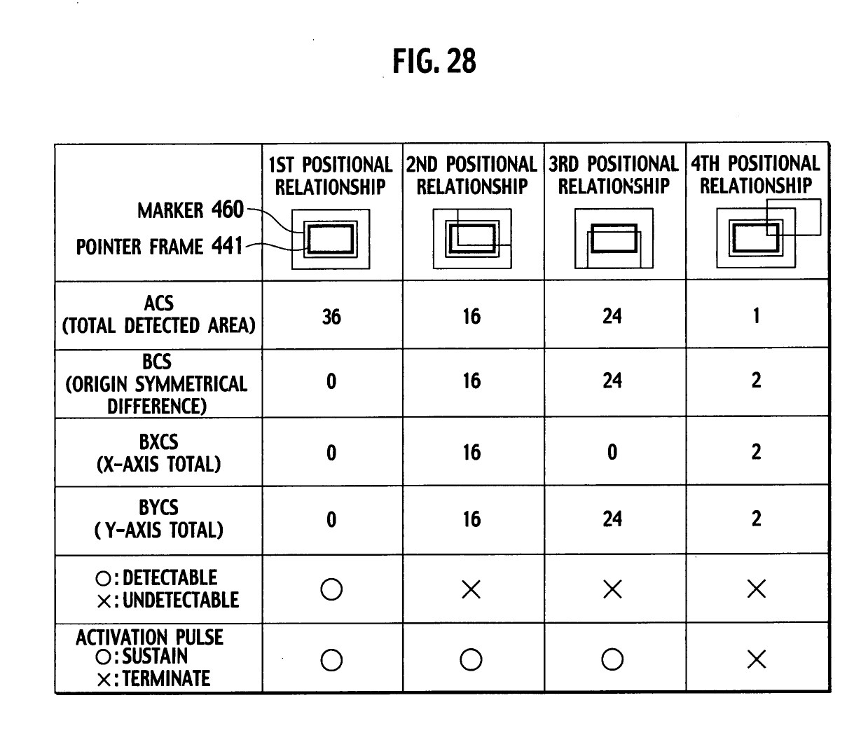

A table shown in FIG. 28 shows results of calculations made for the four positional relationships. For each of the four positional relationships between the marker 460 and the pointer frame 441, the table of FIG. 28 shows evaluation indexes and values obtained from the pointer frame 441. Based on the indexes and values shown in FIG. 28, it is possible to determine whether or not calculated motion vector correction values are effective. According to the determination, an activation pulse for the active zone of the waveform (C) of FIG. 16 is generated. The activation pulse controls the movement of the pointer 450 and detection frame 440 based on calculated motion vector correction values. The activation pulse is useful not only to regulate a positional relationship between the marker 460 and the pointer 450 but also to avoid the influence of unwanted signals such as noise.

In the table of FIG. 28, ACS is the sum total of partial areas of the marker 460 detected in the pointer frame 441. According to the first positional relationship, the marker 460 completely covers the pointer frame 441, and therefore, ACS is at a maximum. According to the other positional relationships, ACS decreases as the marker 460 moves out of the pointer frame 441. BCS is the sum total of the absolute values of origin symmetrical difference values in the pointer frame 441. According to the first positional relationship, all values are symmetrical with respect to the origin, and therefore, BCS is zero. According to the second and third positional relationships, the symmetry breaks, and therefore, BCS shows large values. According to the fourth positional relationship, the marker 460 is substantially out of the pointer frame 441, and therefore, BCS is nearly zero. BCS alone is insufficient for evaluation because it shows similar values for the first and fourth positional relationships. Accordingly, the embodiment employs both ACS and BCS to detect a positional relationship between the marker 460 and the pointer 450, to determine an operation to execute.

This will be explained in detail.

1) Detection of Universal Remote Controller 4A

Detection of the universal remote controller 4A is carried out in the detection zone that stretches for the period indicated with the third arrow in the waveform (C) of FIG. 16. During this period, it is determined whether or not the universal remote controller 4A (marker 460) is projected onto the pointer 450 (pointer frame 441) for a predetermined time. This determination is made by checking to see if ACS is greater than a predetermined value and if BCS indicative of symmetry is smaller than a predetermined value. If these conditions are met, the activation pulse shown in the waveform (C) of FIG. 16 is raised.

2) Sustenance of Activation Pulse

The activation pulse is sustained for the active zone that stretches for the period indicated with the fourth arrow in the waveform (C) of FIG. 16. During this period, the activation pulse is sustained, and the universal remote controller 4A (marker 460) is moved so that the pointer 450 and detection frame 440 may follow the marker 460 according to motion vector correction values. If the sum total of ACS and BCS is larger than a predetermined value or if ACS and BCS are larger than respective predetermined values, the activation pulse is sustained.

3) Termination of Activation Pulse

If the universal remote controller 4A (marker 460) is so fast that the pointer 450 is unable to track the marker 460, or if the marker 460 is beginning to overlap the pointer 440, or if there is unexpected noise, the marker 460 and pointer 450 will take the fourth positional relationship. If ACS detected in the pointer frame 441 is small, the activation pulse is stopped even if BCS is small to indicate symmetry. Namely, the activation pulse in the waveform (C) of FIG. 16 is brought to a low level to stop the motion vector control.

These three types of determination are shown in the table of FIG. 28. In FIG. 28, a detectable positional relationship is indicated with a circle, an undetectable positional relationship with a cross, sustenance of the activation pulse with a circle, and termination of the activation pulse with a cross.

Instead of the origin symmetrical difference value BCS in the table of FIG. 28, it is possible to use BXCS and BYCS that are obtained by multiplying values detected in the four detection sections of the pointer frame 441 by coordinate values and by summing up the products. With BXCS and BYCS, it is possible to evaluate symmetry along the x- and y-axes. For the third positional relationship, for example, there is symmetry along the x-axis. In this case, the motion vector correction is carried out on the x-axis, and no correction is made on the y-axis which shows no symmetry. In this way, areas of the marker 460 in the four detection sections of the pointer frame 441 and symmetry of the areas are evaluated to determine whether or not the motion vector correction must be carried out. With this evaluation, the motion vector correction is stably achievable.

In this way, the embodiment mentioned above detects motion vectors of the marker 460 and moves the detection positions of the detectors and the coordinates of the graphics pointer according to motion vector correction values, to thereby precisely carry out a pointing operation.

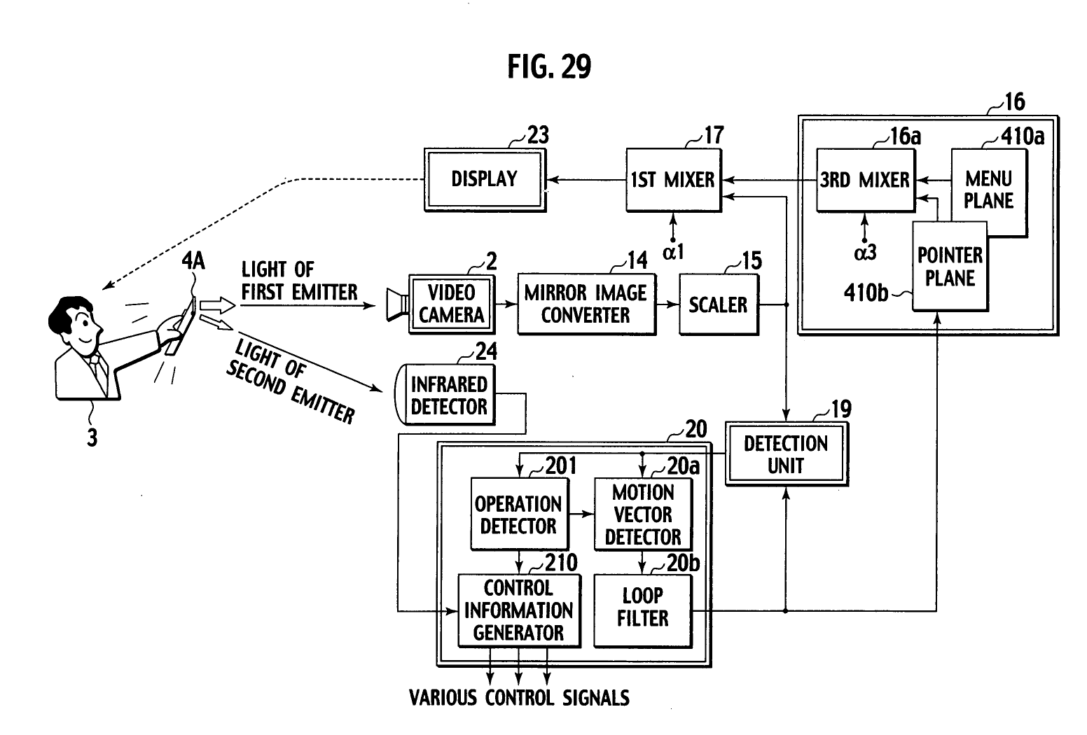

FIG. 29 is a block diagram showing the flow of a motion vector correction signal in an electronic appliance (television set) according to an embodiment of the present invention. FIG. 29 is basically the same as FIG. 2, and therefore, the same functional blocks are represented with the same reference numerals. A menu plane 410a containing control information and a pointer plane 410b are mixed in a graphics generator 16. A display 23 displays the mixed image from the graphics generator 16 and a mirror image of a user 3 carrying the universal remote controller 4A. To choose required control information, the user 3 pushes the universal decision button 310 of the universal remote controller 4A, overlaps the marker 460 on the pointer 450, and moves the marker 460 with the pointer 450. The first emitter 303 of the universal remote controller 4A is photographed with a video camera 2, is passed through a mirror image converter 14 and a scaler 15, is mixed with the image from the graphics generator 16, and is displayed as the marker 460 on the display 23. This forms a first control loop, in which the user 3 manipulates the universal remote controller 4A and guides the pointer 450 to a required position.

The scaler 15 provides images of the user 3 and universal remote controller 4A. From these images, the detection unit 19 provides a control information determining unit (CPU) 20 with data such as a histogram detected in each of the detection sections 1a to 16a of the detection frame 440 shown in FIGS. 15A and 15B. The CPU 20 has an operation detector 201, a control information generator 210, a motion vector detector 20a, and a loop filter 20b. When the marker 460, which is an image of the first emitter 303 of the universal remote controller 4A photographed with the video camera 2, is positioned on the pointer 450 for a predetermined time, the operation detector 201 detects that the active zone shown in the waveform (C) of FIG. 16 has started and issues a flag to operate the motion vector detector 20a. The motion vector detector 20a operates as explained with reference to FIGS. 19 to 24 and calculates vector correction values. The loop filter 20b suppresses a sudden movement due to a sudden motion of the user 3 and minimizes impulse noise due to detection of objects other than the marker 460. According to an output from the loop filter 20b, the detection frame 440 of the detection unit 19 is shifted in the direction in which the universal remote controller 4A is moved. The pointer plane 410b of the graphics generator 16 is similarly shifted, and the pointer plane 410b is mixed with the menu plane 410a in a third mixer 16a. Moving the detection frame 440 according to motion vectors and moving the pointer plane 410b form a second control loop to properly move the pointer 450 according to a positional variation of the universal remote controller 4A.

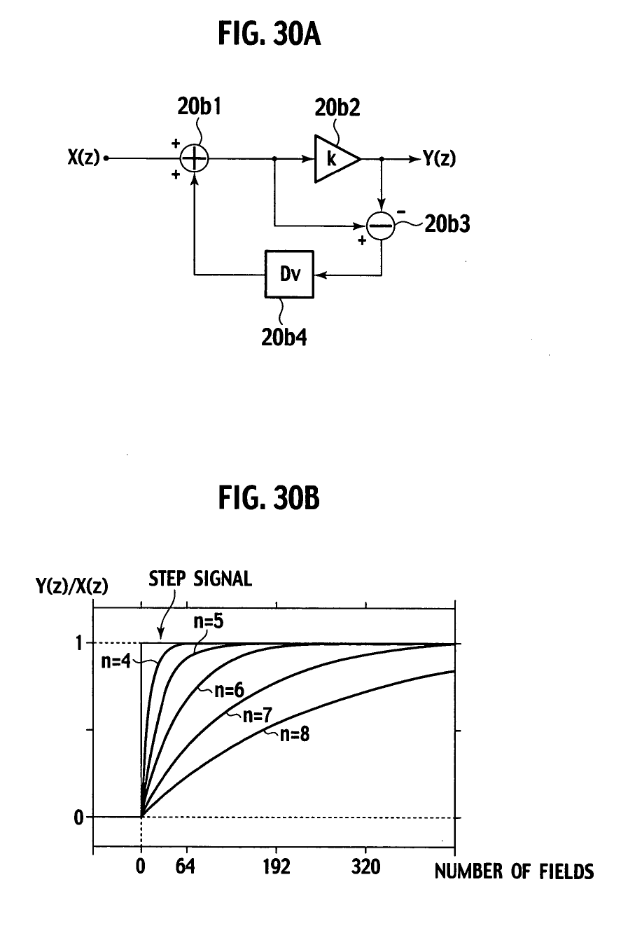

FIGS. 30A and 30B show an example of the loop filter 20b. In FIG. 30A, the loop filter 20 has an adder 20b1, a multiplier 20b2, a subtracter 20b3, and a one-vertical-period delayer 20b4. The characteristic of the loop filter 20 is indicated by the following expression (15).

$$\frac{Y ( z )}{X ( z )} = \frac{1}{ 1 - ( 1 - k ) {Z}^{- 1}} \\ k = \frac{1}{{2}^{n}} , n = 0 , 1 , 2 , 3 , … \qquad ( 15 )$$

where n is an integer equal to or larger than 0. If n is 0, then Y(z)=X(z) so that the filter outputs an input as it is. This filter is a low-pass filter to suppress a sharp variation in an input signal. Namely, the filter can cope with a sudden unintended motion of the user 3 and suppress irregular noise components. The integer n is set to a proper value according to situations.

In this way, the embodiment detects motion vectors of the universal remote controller 4A, and according to the motion vectors, correctly positions the detection frame 440 and the pointer 450 of the graphics generator 16. Namely, the embodiment forms a feedback loop through the user 3 to correctly track the marker 460 with the pointer 450 and carry out a required control operation.

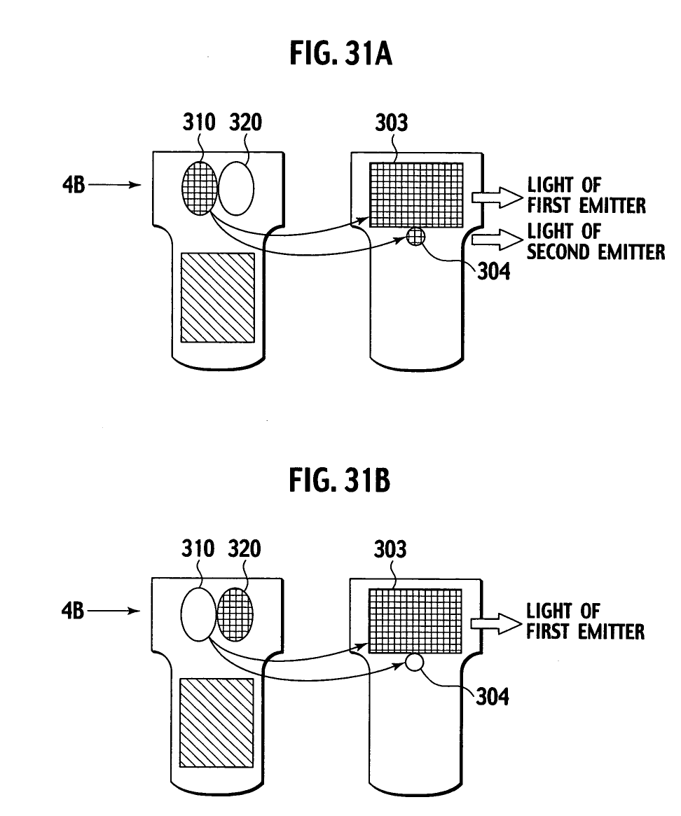

The second example of the present invention will be explained. The second example drags a specific image or an icon having control information with the marker 460. A basic technique employed by the second example is the same as that of the first example. FIGS. 31A and 31B show a universal remote controller 4B according to an embodiment of the present invention, used for the second example. In FIGS. 31A and 31B, the surface of the universal remote controller 4B is shown on the left side and the back thereof on the right side. In addition to a universal decision button 310, which is the same as that explained in the first example, the universal remote controller 4B has a universal move button 320. In FIG. 31A, the universal decision button 310 is hatched to indicate that the button is pushed. At this time, a first emitter 303 and a second emitter 304 on the back of the universal remote controller 4B emit light at predetermined timing. In FIG. 31A, the first and second emitters 303 and 304 are hatched to indicate that they are emitting light. The predetermined timing is shown in the timing chart of FIG. 16.

In FIG. 31B, the universal move button 320 is hatched to indicate that the button is pushed. At this time, only the first emitter 303 on the back of the universal remote controller 4B is emitting light. The second emitter 304 emits no light, and therefore, an infrared decision function is not used. The universal move button 320 is used to move only the pointer 450. A function of detecting light from the first emitter 303 of the universal remote controller 4B is used to move the pointer 450 and select an icon. To determine control information associated with the icon, the universal decision button 310 is pushed. The universal decision button 310 can be used from the beginning to move an icon, and by releasing the button, control information associated with the icon can be determined.

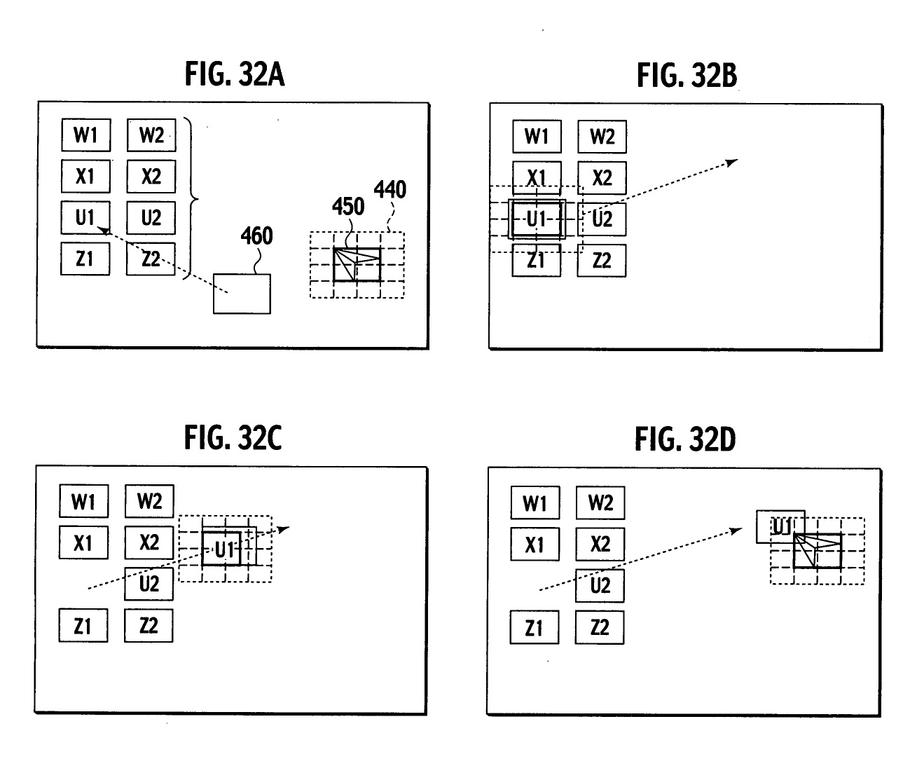

FIGS. 32A to 32D show operation of the universal remote controller 4B. In FIGS. 32A to 32D, a menu displayed on the display 23 includes eight icons W1, W2, X1, X2, U1, U2, Z1, and Z2, the pointer 450, and a marker 460 provided by the video camera 2. Although not visible on the display 23, there is a detection frame 440 corresponding to sixteen detectors 31 to 46 as indicated with dotted lines. The detectors 31 to 46 are the same as those of the first example and are used to remotely control the pointer 450 with the universal remote controller 4B (marker 460). According to the second example, the marker 460 is used to drag and drop an icon instead of the pointer 450.

In FIG. 32A, the marker 460 is a mirror image of the first emitter 303 of the universal remote controller 4B that is emitting light because the universal move button (right button) 320 is pushed. Operation of dragging the icon U1 with the marker 460 to an upper right part of the screen will be explained with reference to FIGS. 32A to 32D. In FIG. 32B, the marker 460 is moved onto the icon U1, which is activated to change its own color. With the change of the color of the icon U1, the user 3 knows that the icon U1 has recognized the marker 460. At this time, the detection frame 440 consisting of the sixteen detection sections moves to the icon U1. From this time point onward, the pointer 450 is not necessary, and therefore, the pointer 450 is not displayed on the screen. Naturally, there is no problem if the pointer 450 is displayed on the screen. The sixteen detectors 31 to 46 for the pointer 450 are continuously used. This is to reduce the size of hardware and software. It is possible to separately arrange detectors for icons and detectors for the pointer 450.

In FIG. 32C, the universal remote controller 4B is moved and the icon U1 follows the movement. A principle of this movement is the same as that of making the pointer 450 follow the marker 460. Namely, the second example moves the icon U1 instead of the pointer 450. At a required position, the user 3 releases the universal move button (right button) 320 to stop moving the icon U1. In FIG. 32D, the icon U1 has been moved, and the detection frame 440 has returned to the pointer 450. The pointer 450 may be returned to the position shown in FIG. 32A. In FIG. 32D, the pointer 450 is on the moved icon U1 so that the icon U1 may easily function. To function the icon U1, the user 3 may push the universal decision button (left button) 310, so that the second emitter 304 emits an infrared remote control decision code to determine control information of the icon U1. If the user 3 uses the universal decision button (left button) 310 from the beginning to move the icon U1, releasing the universal decision button 310 results in determining the control information.

In this way, the universal decision button 310 functions to activate a pointer or an icon, move the same, and finalize a control operation of the same. On the other hand, the universal move button 320 functions to activate a pointer or an icon and move the same. With these buttons 310 and 320, the second example can realize a variety of control modes. For example, a line may be drawn by moving the pointer 450. This operation needs no special control, and therefore, the universal move button 320 is used. The universal move button 320 is also used to move the pointer 450 onto a specific icon or a controller to establish a standby state. In this way, the second example provides a variety of control modes. The two buttons 310 and 320 on the universal remote controller 4B according to the second example can provide functions similar to those provided by two buttons on a mouse of a personal computer. Namely, the buttons 310 and 320 provide the universal remote controller 4B with improved convenience of use.

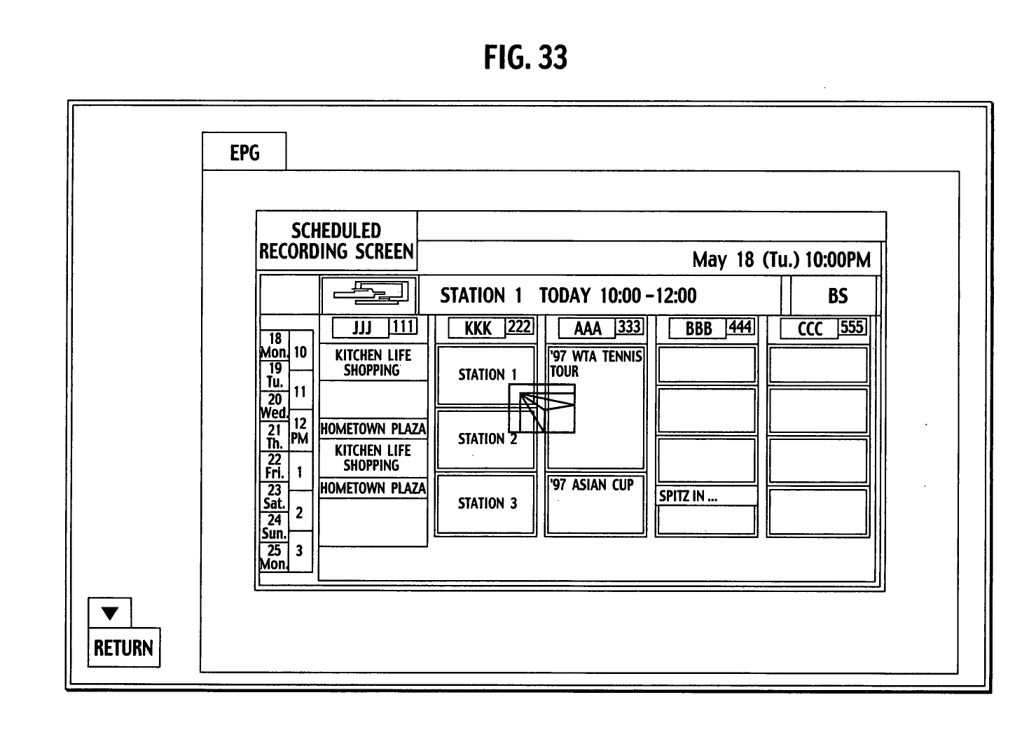

The control technique employing a video camera according to the present invention is applicable to any control image (menu). Application examples of the control technique according to the present invention will be explained. FIG. 33 is a view showing a display screen displaying an EPG (Electronic Program Guide). In the EPG, each program has its own time length to occupy a specific space. Accordingly, a fine pointing operation is needed when specifying a program in the EPG. According to the conventional remote controller, the user must push UP, DOWN, LEFT, and RIGHT keys to bring a pointer onto a required program. This operation is bothersome when the number of programs is large. According to the present invention, the user can directly move a pointer onto a required program. The present invention, therefore, improves convenience of use of the remote controller.

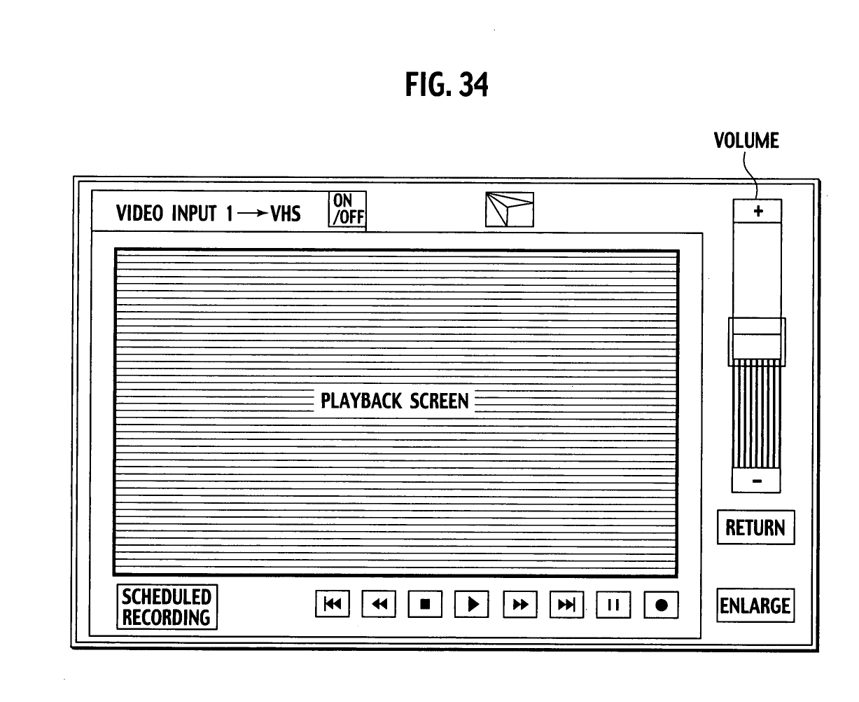

FIG. 34 is a view showing a menu displayed on a display, to playback a recording medium. In FIG. 34, a playback window and a control (GUI) window are displayed in the same screen. The control window includes icons that are controllable with a pointer. A volume slider displayed at the right side of the screen is controllable with the drag and drop function of the second example of the present invention.

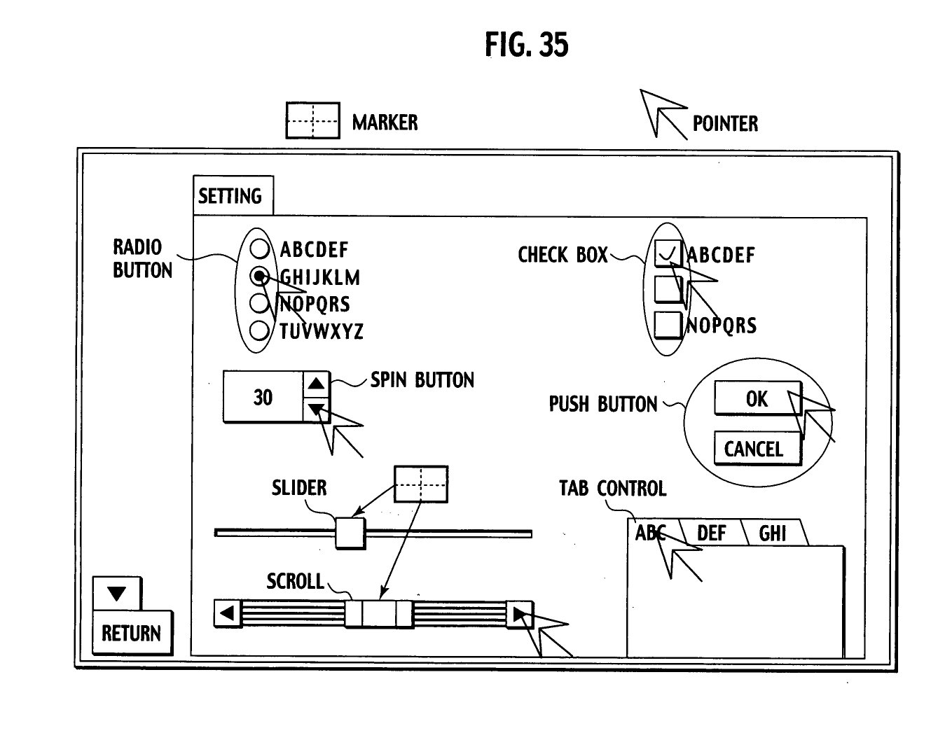

FIG. 35 is a view showing control tools widely used for a personal computer. Each of the control tools is controllable according to the present invention except for entering characters.

Effects of the present invention will be summarized.

1) Unlike the conventional remote controller that forces a user to push a plurality of buttons and alternately see the remote controller and a screen, the universal remote controller according to the present invention requires only one or two buttons to be pushed. The present invention allows a user to conduct a blind operation. The user can manipulate the universal remote controller according to the present invention while continuously seeing a screen.

2) The present invention allows a user to remotely conduct a pointing operation with respect to a television set having a large screen. The present invention realizes easy operation like the GUI of a personal computer for an electronic appliance such as a television set.

3) The present invention increases the degree of freedom of design for menus displayed on a display and for remote controllers which control the menus. As a result, the menus and remote controllers will become smart.

4) In addition to a simple operation of choosing one of two states such as ON and OFF states, the present invention can conduct a continuous control operation on, for example, a volume slider.

Environment around electronic appliances such as television sets is fast changing due to diversification of program broadcasting, data broadcasting, program guiding methods (EPG and the like), home networks, and the Internet. To cope with this, improved electronic appliances are developed and marketed. For such improved electronic appliances, in particular, for those having displays, the present invention can provide an effective user interface.

It should be understood that many modifications and adaptations of the invention will become apparent to those skilled in the art and it is intended to encompass such obvious modifications and changes in the scope of the claims appended hereto.

What is claimed is:

1. An electronics system including an electronic appliance with a display, a video camera for photographing an operator who is in front of the display, and an on-hand controller for remotely controlling the electronic appliance, comprising:
a mirror image converter configured to convert an image photographed with the video camera into a mirror image;
an operational image generator configured to generate an operational image containing at least a control image and a pointing image;
a mixer configured to mix an image signal representative of the mirror image with an image signal representative of the operational image;
a display controller configured to detect that, with the mixed images being displayed on the display, the pointing image has been selected when an image of the on-hand controller photographed with the video camera and displayed on the display is brought over the pointing image on the display and make the pointing image follow a movement of the on-hand controller;
a detection unit configured to detect an operation of specifying the control image according to a position of the pointing image; and
an appliance controller configured to control the electronic appliance according to a control operation associated with the specified control image.

2. The electronics system of claim 1, wherein the display controller:
comprises a plurality of detectors related to a plurality of detection sections, respectively, and configured to detect areas of the image of the on-hand controller in the detection sections, the detection sections being divided from a detection frame that is defined on the display and is used to detect a movement of the on-hand controller;
calculates a motion vector of the on-hand controller according to the sum total of the areas provided by the detectors and the areas provided by the detectors or a difference between the areas detected in each pair of the detection sections that are positionally symmetrical about the center of the detection frame; and
moves the pointing image or the control image according to the calculated motion vector.

3. The electronics system of claim 1, wherein:
the on-hand controller comprises at least one of an infrared emitter configured to emit remote-control infrared light and a visible light emitter configured to emit visible light and vary the visible light, as well as an operation button configured to operate one of the infrared emitter and visible light emitter; and
the detection unit detects the operation of specifying the control image according to a position of the pointing image when the operation button is operated.

4. An electronics system including an electronic appliance with a display, a video camera for photographing an operator who is in front of the display, and an on-hand controller for remotely controlling the electronic appliance, comprising:
a mirror image converter configured to convert an image photographed with the video camera into a mirror image;
an operational image generator configured to generate an operational image containing at least a control image;
a mixer configured to mix an image signal representative of the mirror image with an image signal representative of the operational image; and
a display controller configured to detect that, with the mixed images being displayed on the display, the control image has been selected when an image of the on-hand controller photographed with the video camera and displayed on the display is brought over the control image on the display and make the control image follow a movement of the on-hand controller.

5. The electronics system of claim 4, wherein the display controller:
comprises a plurality of detectors related to a plurality of detection sections, respectively, and configured to detect areas of the image of the on-hand controller in the detection sections, the detection sections being divided from a detection frame that is defined on the display and is used to detect a movement of the on-hand controller;
calculates a motion vector of the on-hand controller according to the sum total of the areas provided by the detectors and the areas provided by the detectors or a difference between the areas detected in each pair of the detection sections that are positionally symmetrical about the center of the detection frame; and
moves the pointing image or the control image according to the calculated motion vector.
